(19) United States
(12) Patent Application Publication
(10) Pub. No.: US 2024/0234879 A1
(43) Pub. Date: Jul. 11, 2024

(54) POWER STORAGE DEVICE PACKAGING MATERIAL AND POWER STORAGE DEVICE INCLUDING THE SAME

(71) Applicant: TOPPAN HOLDINGS INC., Tokyo (JP)

(72) Inventors: Taketo NUMAZAWA, Tokyo (JP); Junya IMAMOTO, Tokyo (JP)

(73) Assignee: TOPPAN HOLDINGS INC., Tokyo (JP)

(21) Appl. No.: 18/613,404

(22) Filed: Mar. 22, 2024

Related U.S. Application Data
(63) Continuation of application No. PCT/JP2022/034623, filed on Sep. 15, 2022.

(30) Foreign Application Priority Data
Sep. 27, 2021 (JP) 2021-156425
Sep. 27, 2021 (JP) 2021-156426

(51) Int. Cl. H01M 50/129; C09J 7/25; C09J 7/30; C09J 7/50; C09J 123/26; C09J 175/04; H01M 50/119; H01M 50/121; H01M 50/178

(52) U.S. Cl. CPC H01M 50/129; C09J 7/25; C09J 7/255; C09J 7/30; C09J 7/50; C09J 123/26; C09J 175/04; H01M 50/119; H01M 50/121; H01M 50/178; C09J 2203/33; C09J 2423/10; C09J 2467/006; C09J 2475/00; C09J 2477/006; C09J 2483/00

(57) ABSTRACT

A power storage device packaging material according to an aspect of the present disclosure includes at least a substrate layer, a first adhesive layer, a primer layer, a barrier layer, a second adhesive layer or an adhesive resin layer, and a sealant layer in this order, wherein by X-ray photoelectron spectroscopy analysis of a surface of the primer layer facing the first adhesive layer, a peak P (Si) derived from Si 2p3/2 is detected in a range of 99 eV to 104 eV, and a peak P(N) derived from N1s is detected in a range of 396 eV to 404 eV, and an area ratio S (Si)/S (N) between a peak area S (Si) of the peak P (Si) and a peak area S (N) of the peak P(N) is 2.0 or less.

### CROSS-REFERENCE TO RELATED PATENT APPLICATIONS

This application is a continuation application filed under 35 U.S.C. § 111(a) claiming the benefit under 35 U.S.C. §§ 120 and 365(c) of International Patent Application No. PCT/JP2022/034623, filed on Sep. 15, 2022, which is based upon and claims the benefit to Japanese Patent Application No. 2021-156425 filed on Sep. 27, 2021 and Japanese Patent Application No. 2022-156426 filed on Sep. 27, 2021, the disclosures of which are incorporated herein by reference in their entirety.

### TECHNICAL FIELD

The present disclosure relates to a power storage device packaging material and a power storage device including the same.

### BACKGROUND ART

Known examples of power storage devices include secondary batteries such as lithium-ion batteries, nickel hydride batteries, and lead batteries, and electrochemical capacitors such as electric double layer capacitors. As mobile devices have been downsized or limited in installation space, there have been demands for further downsized power storage devices. Accordingly, lithium-ion batteries having high energy density have been attracting attention. Conventional packaging materials for lithium-ion batteries have been metal cans; however, multilayer films have been increasingly used due to their light weight, high heat dissipation, and low production cost.

Lithium-ion batteries including such a multilayer film as a packaging material are referred to as laminated lithium-ion batteries. The packaging material covers battery contents (a positive electrode, a separator, a negative electrode, an electrolyte solution, etc.) to prevent moisture from penetrating into the lithium-ion batteries. A laminated lithium-ion battery is produced, for example, by forming a recess in a portion of a packaging material by cold forming, placing battery contents in the recess, folding the remaining part of the packaging material, and sealing the edge portions by heat sealing (see, for example, PTL 1).

[Citation List] [Patent Literatures] [PTL 1] JP 2013-101765 A

### SUMMARY OF THE INVENTION

### Technical Problem

Power storage devices referred to as all-solid-state batteries are under research and development as next-genebriration batteries replacing lithium-ion batteries. All-solid-state batteries are characterized by including a solid electrolyte instead of an organic electrolyte solution as an electrolyte material. Lithium-ion batteries cannot be used under temperature conditions higher than the boiling point temperature of the electrolyte solution (approximately 80° C.). However, all-solid-state batteries can be used under temperature conditions higher than 100° C., and can enhance the conductivity of lithium ions when the batteries are operated under high temperature conditions (e.g., 100 to 150° C.).

### First Object

When a multilayer film as described above is used as a packaging material to produce a laminated all-solid-state battery, insufficient heat resistance of the packaging material may lead to lack of interlayer adhesion under high temperature environmental conditions, causing lower lamination strength and resulting in poor sealing performance of the package of the all-solid-state battery. As described in Patent Literature 1, a packaging material has, for example, a structure in which a substrate layer, a metal foil layer (barrier layer), and a sealant layer are laminated via an adhesive layer or the like, and the adhesion between the substrate layer and the barrier layer is more likely to be reduced under high temperature environmental conditions.

The present disclosure has been made in view of the above problem, and a first object of the present disclosure is to provide a power storage device packaging material capable of ensuring good lamination strength under both room temperature environmental conditions and high temperature environmental conditions, and a power storage device including the power storage device packaging material.

### Second Object

When a multilayer film as described above is used as a packaging material to produce a laminated all-solid-state battery, insufficient heat resistance of the packaging material may lead to lack of interlayer adhesion (adhesion between the heat-sealed layers) under high temperature environmental conditions after heat sealing, causing lower heat sealing strength and resulting in poor sealing performance of the package of the all-solid-state battery.

The present disclosure has been made in view of the above problem, and a second object of the present disclosure is to provide a power storage device packaging material capable of ensuring good heat sealing strength under both room temperature environmental conditions and high temperature environmental conditions, and a power storage device including the power storage device packaging material.

### Solution to Problem

### First Aspect

In order to achieve the first object, the present disclosure provides a power storage device packaging material including at least a substrate layer, a first adhesive layer, a primer layer, a barrier layer, a second adhesive layer or an adhesive resin layer, and a sealant layer in this order, wherein by X-ray photoelectron spectroscopy analysis of a surface of the primer layer facing the first adhesive layer, a peak P (Si) derived from Si 2p3/2 is detected in a range of 99 eV to 104 eV, and a peak P(N) derived from N1s is detected in a range of 396 eV to 404 eV, and an area ratio S (Si)/S (N) between a peak area S (Si) of the peak P (Si) and a peak area S (N) of the peak P(N) is 2.0 or less.

In a conventional power storage device packaging material, a substrate layer and a barrier layer are bonded to each other with an adhesive layer, and the adhesive layer and the barrier layer are considered to be adhered to each other due to intermolecular interaction such as hydrogen bonding. However, under high temperature environmental conditions (e.g., in a 150° C. environment), high thermal energy applied to the packaging material leads to a reduction in intermolecular interaction, resulting in a great reduction in lamination strength. On the other hand, in the power storage device packaging material of the present disclosure, the primer layer in which the peak P (Si) and the peak P(N) are detected and that is provided between the first adhesive layer and the barrier layer can improve the adhesion between the substrate layer and the barrier layer, maintaining high lamination strength even under high temperature environmental conditions (e.g., in a 150° C. environment). In particular, the area ratio S (Si)/S (N) in the primer layer is 2.0 or less; thus, a covalent bond is more likely to be formed at both the interface between the primer layer and the barrier layer and the interface between the primer layer and the first adhesive layer, leading to formation of a covalent bond network via the primer layer between the substrate layer and the barrier layer. Covalent bonds are less likely to be broken even under high temperature environmental conditions, and thus the packaging material can have high heat resistance and maintain high lamination strength.

The power storage device packaging material is preferably configured such that the barrier layer is a metal foil made of aluminum or an aluminum alloy, and by X-ray photoelectron spectroscopy analysis of the surface of the primer layer facing the first adhesive layer, a peak P (Al) derived from Al 2p3/2 is detected in a range of 70 eV to 78 eV. The peak P (Al) is a peak derived from the barrier layer, and detection of the peak means that the primer layer is a monomolecular film or a thin film of approximately 10 nm or less, from the resolution in the depth direction of the X-ray photoelectron spectroscopy. In the case where the primer layer is a monomolecular film or a thin film as described above, cohesive failure of the primer layer can be prevented, achieving higher adhesion as compared with the case where the primer layer is thick.

The power storage device packaging material is preferably configured such that the primer layer is a layer that is composed of a primer layer forming composition containing a silane coupling agent and that is formed through a dehydration condensation reaction of the silane coupling agent. A silane coupling agent is preferable as a component of the primer layer from the viewpoint of cost, handleability, and safety. The primer layer formed through a dehydration condensation reaction of a silane coupling agent can achieve even higher lamination strength under both room temperature environmental conditions and high temperature environmental conditions.

The power storage device packaging material is preferably configured such that the silane coupling agent is a compound having an amino group or an isocyanate group. By using a silane coupling agent having such a functional group, a covalent bond unit formed between the first adhesive layer and the primer layer is more likely to be increased, achieving even higher lamination strength particularly under high temperature environmental conditions.

The power storage device packaging material is preferably configured to include an anticorrosion treatment layer at one or both of a position between the barrier layer and the primer layer and a position between the second adhesive layer and the barrier layer. The power storage device packaging material including the anticorrosion treatment layer can have even higher adhesion between the barrier layer and the primer layer. When the power storage device packaging material is used for an all-solid-state battery, depending on the type of solid electrolyte, corrosive gas such as hydrogen sulfide may be generated by a reaction of the solid electrolyte with water. However, the anticorrosion treatment layer provided between the barrier layer and the primer layer can ensure heat resistance and corrosion resistance.

The power storage device packaging material is preferably configured such that the first adhesive layer is a layer that is composed of an adhesive composition containing a polyfunctional isocyanate compound, and the polyfunctional isocyanate compound is at least one polyfunctional isocyanate compound selected from a group consisting of an alicyclic isocyanate multimer and an isocyanate multimer having a molecular structure containing an aromatic ring. The use of a polyfunctional isocyanate compound having the above structure can achieve even higher lamination strength under both room temperature environmental conditions and high temperature environmental conditions. In particular, an alicyclic isocyanate multimer has a bulky molecular structure, and thus a mixture of molecular chains is less likely to be loosened even under high temperature environmental conditions, and higher heat resistance is more likely to be achieved. Furthermore, due to intermolecular interaction, an isocyanate multimer containing an aromatic ring is more likely to achieve higher adhesion even under room temperature environmental conditions.

The power storage device packaging material is preferably configured such that the adhesive composition is a urethane adhesive composition containing at least one polyol selected from a group consisting of a polyester polyol, an acrylic polyol, and a polycarbonate diol, and the polyfunctional isocyanate compound. The use of the specific polyol can achieve even higher lamination strength particularly under high temperature environmental conditions.

The power storage device packaging material is preferably configured such that in the adhesive composition, a ratio (NCO/OH) of a number of isocyanate groups contained in the polyfunctional isocyanate compound to a number of hydroxyl groups contained in the polyol is 1.5 to 40.0. The NCO/OH ratio in the above range can achieve even higher lamination strength under room temperature environmental conditions and high temperature environmental conditions. In particular, a high NCO/OH ratio is more likely to achieve higher heat resistance. This is presumably because the amount of curing agent being sufficiently larger than the amount of base resin leads to a reaction of the curing agent, forming a by-product such as a urea resin or a biuret resin. Presumably, an active hydrogen group contained in such a by-product interacts with a polar group of an adjacent layer and achieves higher interface adhesion, thus leading to higher heat resistance.

The power storage device packaging material is preferably configured such that the substrate layer is a polyamide film or a polyester film. The use of such a resin film as the substrate layer allows the power storage device packaging material to have higher heat resistance and formability.

The power storage device packaging material may be used for an all-solid-state battery.

The present disclosure provides a power storage device including a power storage device body, a current output terminal that extends from the power storage device body, and the power storage device packaging material of the present disclosure, the power storage device packaging material sandwiching the current output terminal and housing the power storage device body. The power storage device may be an all-solid-state battery.

### Second Aspect

In order to achieve the second object, the present disclosure provides a power storage device packaging material including at least a substrate layer, a first adhesive layer, a barrier layer, a second adhesive layer or an adhesive resin layer, and a sealant layer in this order, wherein the power storage device packaging material includes a primer layer at a position between layers from the barrier layer to the sealant layer, by X-ray photoelectron spectroscopy analysis of a surface of the primer layer facing the sealant layer, a peak P (Si) derived from Si 2p3/2 is detected in a range of 99 eV to 104 eV, and a peak P(N) derived from N1s is detected in a range of 396 eV to 404 eV, and an area ratio S (Si)/S (N) between a peak area S (Si) of the peak P (Si) and a peak area S (N) of the peak P(N) is 2.0 or less.

In a conventional power storage device packaging material, a sealant layer and a barrier layer are bonded to each other with an adhesive resin layer or an adhesive layer, and the adhesive resin layer or the adhesive layer and the barrier layer are considered to be adhered to each other due to intermolecular interaction such as hydrogen bonding. However, under high temperature environmental conditions (e.g., in a 150° C. environment), high heat energy applied to the packaging material leads to a reduction in intermolecular interaction, resulting in a great reduction in adhesion. On the other hand, in the power storage device packaging material of the present disclosure, the primer layer in which the peak P (Si) and the peak P(N) are detected and that is provided at a position between layers from the barrier layer to the sealant layer can improve the adhesion between the sealant layer and the barrier layer (e.g., between the adhesive resin layer or the adhesive layer and the barrier layer), maintaining high heat sealing strength even under high temperature environmental conditions (e.g., in a 150° C. environment). In particular, the area ratio S (Si)/S (N) in the primer layer is 2.0 or less; thus, a covalent bond is more likely to be formed at both the interface between the primer layer and the barrier layer and the interface between the primer layer and the adhesive resin layer or the adhesive layer, leading to formation of a covalent bond network via the primer layer between the adhesive resin layer or the adhesive layer and the barrier layer. The covalent bond is less likely to be broken even under high temperature environmental conditions, and thus the packaging material can have high heat resistance and maintain high heat sealing strength.

The power storage device packaging material is preferably configured such that the barrier layer is a metal foil made of aluminum or an aluminum alloy, and by X-ray photoelectron spectroscopy analysis of the surface of the primer layer facing the sealant layer, a peak P (Al) derived from Al 2p3/2 is detected in a range of 70 eV to 78 eV. The peak P (Al) is a peak derived from the barrier layer, and detection of the peak means that the primer layer is a monomolecular film or a thin film of approximately 10 nm or less, from the resolution in the depth direction of the X-ray photoelectron spectroscopy. In the case where the primer layer is a monomolecular film or a thin film as described above, cohesive failure of the primer layer can be prevented, achieving higher adhesion as compared with the case where the primer layer is thick.

The power storage device packaging material is preferably configured such that the primer layer is a layer that is composed of a primer layer forming composition containing a silane coupling agent and that is formed through a dehydration condensation reaction of the silane coupling agent. A silane coupling agent is preferable as a component of the primer layer from the viewpoint of cost, handleability, and safety. The primer layer formed through a dehydration condensation reaction of a silane coupling agent can achieve even higher heat scaling strength under both room temperature environmental conditions and high temperature environmental conditions.

The power storage device packaging material is preferably configured such that the silane coupling agent is a compound having an amino group. By using a silane coupling agent having an amino group, a covalent bond unit formed between the adhesive resin layer or the adhesive layer and the primer layer is more likely to be increased, achieving even higher heat sealing strength particularly under high temperature environmental conditions.

The power storage device packaging material is preferably configured to include an anticorrosion treatment layer at one or both of a position between the barrier layer and the first adhesive layer and a position between the primer layer and the barrier layer. The power storage device packaging material including the anticorrosion treatment layer can have even higher adhesion between the barrier layer and the primer layer. When the power storage device packaging material is used for an all-solid-state battery, depending on the type of solid electrolyte, corrosive gas such as hydrogen sulfide may be generated by a reaction of the solid electrolyte with water. However, the anticorrosion treatment layer provided between the barrier layer and the primer layer can ensure heat resistance and corrosion resistance.

The power storage device packaging material is preferably configured such that the adhesive resin layer contains acid-modified polyolefin. This allows the power storage device packaging material to have even higher adhesion between the adhesive resin layer and the barrier layer via the primer layer, achieving even higher heat sealing strength under both room temperature environmental conditions and high temperature environmental conditions.

The power storage device packaging material is preferably configured such that both the adhesive resin layer and the sealant layer contain polypropylene, and one or both of the adhesive resin layer and the sealant layer contain long-chain branched polypropylene as the polypropylene. The addition of long-chain branched polypropylene to at least one of the adhesive resin layer and the sealant layer can achieve even higher heat resistance. This is presumably because the entanglement of resin in the layers becomes strong under high temperature environmental conditions. From the viewpoint of enhancing the above effect, long-chain branched polypropylene is preferably contained in at least the adhesive resin layer, and more preferably contained in both the adhesive resin layer and the sealant layer.

The power storage device packaging material is preferably configured such that a content of the long-chain branched polypropylene with respect to a total amount of resin in the adhesive resin layer and the sealant layer is 0.5 to 30 mass %. When the content is 0.5 mass % or more, the entanglement of resin is increased, enhancing the effect of achieving higher heat resistance. When the content is 30 mass % or less, it is possible to prevent the packaging material from having lower heat sealing strength in the initial stage (under room temperature environmental conditions) and at high temperature. This is presumably because the long-chain branched polypropylene content of 30 mass % or less can prevent the entanglement of resin from becoming excessively large and causing lower fluidity of the resin. When the packaging material is heat-scaled, the lower fluidity of the resin may inhibit an accumulation of resin that contributes to higher sealing strength from being formed near the inner edge of the sealed portion. However, presumably, when the long-chain branched polypropylene content is 30 mass % or less, the formation of an accumulation of resin is not inhibited.

The power storage device packaging material is preferably configured such that a thickness ratio between the adhesive resin layer and the sealant layer (thickness of the adhesive resin layer/thickness of the sealant layer) is 0.06 to 1. This allows the power storage device packaging material to have even higher heat sealing strength in the initial stage (under room temperature environmental conditions) and at high temperature.

The power storage device packaging material may be used for an all-solid-state battery.

The present disclosure provides a power storage device including a power storage device body, a current output terminal that extends from the power storage device body, and the power storage device packaging material of the present disclosure, the power storage device packaging material sandwiching the current output terminal and housing the power storage device body. The power storage device may be an all-solid-state battery.

### Advantageous Effects of the Invention

The first aspect of the present disclosure provides a power storage device packaging material capable of ensuring good lamination strength under both room temperature environmental conditions and high temperature environmental conditions, and a power storage device including the power storage device packaging material.

The second aspect of the present disclosure provides a power storage device packaging material capable of ensuring good heat sealing strength under both room temperature environmental conditions and high temperature environmental conditions, and a power storage device including the power storage device packaging material.

### BRIEF DESCRIPTION OF THE DRAWINGS

FIG. 1 is a schematic cross-sectional view of a power storage device packaging material according to an embodiment of the present disclosure.

FIG. 2 is a schematic cross-sectional view of a power storage device packaging material according to an embodiment of the present disclosure.

FIG. 3 is a schematic cross-sectional view of a power storage device packaging material according to an embodiment of the present disclosure.

FIG. 4 is a schematic cross-sectional view of a power storage device packaging material according to an embodiment of the present disclosure.

FIG. 5 is a schematic cross-sectional view of a power storage device packaging material according to an embodiment of the present disclosure.

FIG. 6 is a perspective view of a power storage device according to an embodiment of the present disclosure.

FIG. 7 is a schematic diagram illustrating a method of preparing a sample for measurement of heat sealing strength in examples.

### DETAILED DESCRIPTION

Preferred embodiments of the present disclosure will be described below in detail with reference to the drawings as appropriate. In the drawings, the same or corresponding components are denoted by the same reference numerals, and redundant description is omitted. Furthermore, dimensional ratios in the drawings are not limited to the ratios shown in the drawings.

In the following description, the configuration of the first aspect may be applied to the second aspect, and the configuration of the second aspect may be applied to the first aspect.

The present disclosure provides a power storage device packaging material described below and a power storage device including the same.
[1] A power storage device packaging material including at least a substrate layer, a first adhesive layer, a primer layer, a barrier layer, a second adhesive layer or an adhesive resin layer, and a sealant layer in this order, wherein by X-ray photoelectron spectroscopy analysis of a surface of the primer layer facing the first adhesive layer, a peak P (Si) derived from Si 2p3/2 is detected in a range of 99 eV to 104 eV, and a peak P(N) derived from N1s is detected in a range of 396 eV to 404 eV, and an area ratio S (Si)/S (N) between a peak area S (Si) of the peak P (Si) and a peak area S (N) of the peak P(N) is 2.0 or less.
[2] The power storage device packaging material according to [1], wherein the barrier layer is a metal foil made of aluminum or an aluminum alloy, and by X-ray photoelectron spectroscopy analysis of the surface of the primer layer facing the first adhesive layer, a peak P (Al) derived from Al 2p3/2 is detected in a range of 70 eV to 78 eV.
[3] The power storage device packaging material according to [1] or [2], wherein the primer layer is a layer that is composed of a primer layer forming composition containing a silane coupling agent and that is formed through a dehydration condensation reaction of the silane coupling agent.
[4] The power storage device packaging material according to [3], wherein the silane coupling agent is a compound having an amino group or an isocyanate group.
[5] The power storage device packaging material according to any one of [1] to [4], including an anticorrosion treatment layer at one or both of a position between the barrier layer and the primer layer and a position between the second adhesive layer and the barrier layer.
[6] The power storage device packaging material according to any one of [1] to [5], wherein the first adhesive layer is a layer that is composed of an adhesive composition containing a polyfunctional isocyanate compound, and the polyfunctional isocyanate compound is at least one polyfunctional isocyanate compound selected from a group consisting of an alicyclic isocyanate multimer and an isocyanate multimer having a molecular structure containing an aromatic ring.
[7] The power storage device packaging material according to [6], wherein the adhesive composition is a urethane adhesive composition containing at least one polyol selected from a group consisting of a polyester polyol, an acrylic polyol, and a polycarbonate diol, and the polyfunctional isocyanate compound.
[8] The power storage device packaging material according to [7], wherein a ratio (NCO/OH) of a number of isocyanate groups contained in the polyfunctional isocyanate compound to a number of hydroxyl groups contained in the polyol is 1.5 to 40.0.
[9] The power storage device packaging material according to any one of [1] to [8], wherein the substrate layer is a polyamide film or a polyester film.
[10] A power storage device packaging material including at least a substrate layer, a first adhesive layer, a barrier layer, a second adhesive layer or an adhesive resin layer, and a sealant layer in this order, wherein the power storage device packaging material includes a primer layer at a position between layers from the barrier layer to the sealant layer, by X-ray photoelectron spectroscopy analysis of a surface of the primer layer facing the sealant layer, a peak P (Si) derived from Si 2p3/2 is detected in a range of 99 eV to 104 eV, and a peak P(N) derived from N1s is detected in a range of 396 eV to 404 eV, and an area ratio S (Si)/S (N) between a peak area S (Si) of the peak P (Si) and a peak area S (N) of the peak P(N) is 2.0 or less.
[11] The power storage device packaging material according to [10], wherein the barrier layer is a metal foil made of aluminum or an aluminum alloy, and by X-ray photoelectron spectroscopy analysis of the surface of the primer layer facing the sealant layer, a peak P (Al) derived from Al 2p3/2 is detected in a range of 70 eV to 78 eV.
[12] The power storage device packaging material according to [10] or [11], wherein the primer layer is a layer that is composed of a primer layer forming composition containing a silane coupling agent and that is formed through a dehydration condensation reaction of the silane coupling agent.
[13] The power storage device packaging material according to [12], wherein the silane coupling agent is a compound having an amino group.
[14] The power storage device packaging material according to any one of [10] to [13], including an anticorrosion treatment layer at one or both of a position between the barrier layer and the first adhesive layer and a position between the primer layer and the barrier layer.
[15] The power storage device packaging material according to any one of [10] to [14], wherein the adhesive resin layer contains acid-modified polyolefin.
[16] The power storage device packaging material according to any one of [10] to [15], wherein both the adhesive resin layer and the sealant layer contain polypropylene, and one or both of the adhesive resin layer and the sealant layer contain long-chain branched polypropylene as the polypropylene.
[17] The power storage device packaging material according to [16], wherein a content of the long-chain branched polypropylene with respect to a total amount of resin in the adhesive resin layer and the sealant layer is 0.5 to 30 mass %.
[18] The power storage device packaging material according to any one of
[10] to [17], wherein a thickness ratio between the adhesive resin layer and the sealant layer (thickness of the adhesive resin layer/thickness of the sealant layer) is 0.06 to 1.
[19] The power storage device packaging material according to any one of [1] to [18], wherein the power storage device packaging material is used for an all-solid-state battery.
[20] A power storage device including a power storage device body, a current output terminal that extends from the power storage device body, and the power storage device packaging material according to any one of [1] to [19], the power storage device packaging material sandwiching the current output terminal and housing the power storage device body.
[21] The power storage device according to [20], wherein the power storage device is an all-solid-state battery.

### Power Storage Device Packaging Material

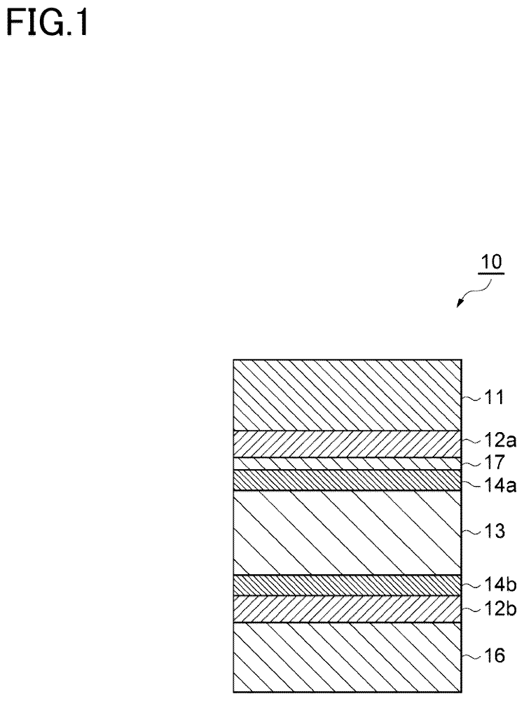

FIG. 1 is a schematic cross-sectional view of an embodiment of a power storage device packaging material according to the first aspect of the present disclosure. As shown in FIG. 1, a packaging material (power storage device packaging material) 10 according to the first aspect of the present embodiment is a laminate including a substrate layer 11, a first adhesive layer 12a provided on one surface of the substrate layer 11, a primer layer 17 provided on the side of the first adhesive layer 12a facing away from the substrate layer 11, a barrier layer 13 provided on the side of the primer layer 17 facing away from the first adhesive layer 12a and having anticorrosion treatment layers (first anticorrosion treatment layer 14a and second anticorrosion treatment layer 14b) on the respective surfaces thereof, a second adhesive layer 12b provided on the side of the barrier layer 13 facing away from the first adhesive layer 12a, and a sealant layer 16 provided on the side of the second adhesive layer 12b facing away from the barrier layer 13. The first anticorrosion treatment layer 14a is provided on the surface of the barrier layer 13 facing the substrate layer 11, and the second anticorrosion treatment layer 14b is provided on the surface of the metal barrier layer 13 facing the sealant layer 16. In the packaging material 10, the substrate layer 11 is the outermost layer, and the sealant layer 16 is the innermost layer. That is, the packaging material 10 is used so that the substrate layer 11 faces the outside of the power storage device and the sealant layer 16 faces the inside of the power storage device.

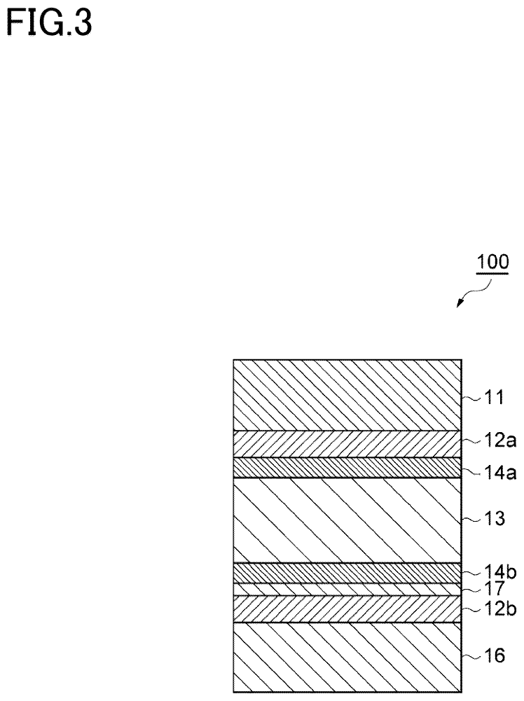

FIG. 3 is a schematic cross-sectional view of an embodiment of a power storage device packaging material according to the second aspect of the present disclosure. As shown in FIG. 3, a packaging material (power storage device packaging material) 100 according to the second aspect of the present embodiment is a laminate including the substrate layer 11, the first adhesive layer 12a provided on one surface of the substrate layer 11, the barrier layer 13 provided on the side of the first adhesive layer 12a facing away from the substrate layer 11 and having anticorrosion treatment layers (first anticorrosion treatment layer 14a and second anticorrosion treatment layer 14b) on the respective surfaces thereof, the primer layer 17 provided on the side of the barrier layer 13 facing away from the first adhesive layer 12a, the second adhesive layer 12b provided on the side of the primer layer 17 facing away from the barrier layer 13, and the sealant layer 16 provided on the side of the second adhesive layer 12b facing away from the primer layer 17. The first anticorrosion treatment layer 14a is provided on the surface of the barrier layer 13 facing the substrate layer 11, and the second anticorrosion treatment layer 14b is provided on the surface of the metal barrier layer 13 facing the sealant layer 16. In the packaging material 100, the substrate layer 11 is the outermost layer, and the sealant layer 16 is the innermost layer. That is, the packaging material 100 is used so that the substrate layer 11 faces the outside of the power storage device and the sealant layer 16 faces the inside of the power storage device.

The layers constituting the packaging materials 10 and 100 will be specifically described below.

### Substrate layer 11

The substrate layer 11 allows the packaging material to have heat resistance in a sealing process during production of the power storage device and prevents the possible occurrence of pinholes during forming processing and distribution. In packaging materials for large power storage devices in particular, the substrate layer 11 can also allow the packaging materials to have scratch resistance, chemical resistance, insulating properties, and the like.

The substrate layer 11 is preferably composed of a resin having insulating properties. Examples of the resin include a polyester resin, a polyamide resin, a polyimide resin, a polyamideimide resin, a polyether ketone resin, a polyphenylene sulfide resin, a polyetherimide resin, a polysulfone resin, a fluororesin, a phenol resin, a melamine resin, a urethane resin, an allyl resin, a silicon resin, an epoxy resin, a furan resin, and an acetylcellulose resin.

When such a resin is applied to the substrate layer 11, the resin may be used in the form of stretched film or unstretched film or in the form of coating film. Furthermore, the substrate layer 11 may be a single layer or a multilayer, and the substrate layer 11 as a multilayer may be composed of a combination of different resins. When the substrate layer 11 is a film, the substrate layer 11 may be a film obtained by coextrusion or a film obtained by lamination via an adhesive. When the substrate layer 11 is a coating film, the substrate layer 11 may be a coating film obtained by performing coating the number of times required to form a laminate. The substrate layer 11 may be a multilayer including a film and a coating film in combination.

Of the above resins, a polyester resin and a polyamide resin have good formability and thus are preferable materials for forming the substrate layer 11. Examples of the polyester resin include polyethylene terephthalate, polybutylene terephthalate, and polyethylene naphthalate. Examples of the polyamide resin include nylon 6, nylon 6,6, a copolymer of nylon 6 and nylon 6,6, nylon 6, nylon 9T, nylon 10, polymetaxylylene adipamide (MXD6), nylon 11, and nylon 12.

When such a resin is used in the form of film, the resin is preferably used in the form of biaxially stretched film. The biaxially stretched film may be obtained, for example, by sequential biaxial stretching, tubular biaxial stretching, simultaneous biaxial stretching, or the like. The biaxially stretched film is preferably obtained by tubular biaxial stretching from the viewpoint of achieving better deep drawing formability.

The substrate layer 11 preferably has a thickness of 6 to 100 μm, more preferably 10 to 75 μm, and still more preferably 10 to 50 μm. When the thickness of the substrate layer 11 is 6 μm or more, the packaging materials 10 and 100 tend to have better pinhole resistance and insulating properties. When the thickness of the substrate layer 11 is 50 μm or less, the total thickness of the packaging materials 10 and 100 tends to be small.

The substrate layer 11 preferably has a higher melting peak temperature than the sealant layer 16. In the case where the sealant layer 16 has a multilayer structure, the melting peak temperature of the sealant layer 16 means the melting peak temperature of a layer of the sealant layer 16 having the highest melting peak temperature. The substrate layer 11 having a higher melting peak temperature than the sealant layer 16 can prevent the packaging materials 10 and 100 from having a poor appearance due to melting of the substrate layer 11 (outer layer) during heat sealing.

The melting peak temperature of the substrate layer 11 is preferably 290° C. or higher, and more preferably 290 to 350° C. A resin film that can be used as the substrate layer 11 and has a melting peak temperature in the above range may be a nylon film, a polyester film such as a PET film, a polyamide film, a polyphenylene sulfide film (PPS film), or the like. The substrate layer 11 may be a commercially available film or may be a coating film (obtained by applying and drying a coating liquid). The substrate layer 11 may have a single-layer structure or a multilayer structure or may be formed by applying a thermosetting resin. The substrate layer 11 may contain, for example, various additives (e.g., a flame retardant, a slip agent, an anti-blocking agent, an antioxidant, a photostabilizer, a tackifier, etc.).

The difference (T₁₁-T₁₆) between the melting peak temperature T₁₁ of the substrate layer 11 and the melting peak temperature T₁₆ of the sealant layer 16 is preferably 20° C. or more. When the temperature difference is 20° C. or more, it is possible to more sufficiently prevent the packaging materials 10 and 100 from having a poor appearance due to heat sealing.

### First Adhesive Layer 12a

The first adhesive layer 12a adheres the substrate layer 11 to the barrier layer 13. Specific examples of a material for forming the first adhesive layer 12a include a polyurethane resin obtained by allowing a bi- or higher-functional isocyanate compound (polyfunctional isocyanate compound) to act on a base resin such as a polyester polyol, a polyether polyol, an acrylic polyol, or a carbonate polyol. The various polyols described above can be used singly or in combination of two or more, according to the function and performance required for the packaging materials 10 and 100. Other than the above materials, examples of the material for forming the first adhesive layer 12a include, but are not limited to, a material obtained by adding a curing agent to an epoxy resin as a base resin.

The first adhesive layer 12a is composed of an adhesive composition containing one of the above base resins and a curing agent. Other various additives and stabilizers may be added to the adhesive composition described above, according to the performance required for the adhesive layer.

The adhesive composition preferably contains, as a curing agent, at least one polyfunctional isocyanate compound selected from the group consisting of an alicyclic isocyanate multimer and an isocyanate multimer having a molecular structure containing an aromatic ring. Examples of the polyfunctional isocyanate compound include an isocyanurate of isophorone diisocyanate, an adduct of tolylene diisocyanate, an adduct of hexamethylene diisocyanate, a biuret and isocyanurate of hexamethylene diisocyanate, a biuret and isocyanurate of tolylene diisocyanate, an adduct, biuret, and isocyanurate of diphenylmethane diisocyanate, and an adduct, biuret, and isocyanurate of xylylene diisocyanate.

The adhesive composition may contain, as a curing agent, a combination of an alicyclic isocyanate multimer and an isocyanate multimer having a molecular structure containing an aromatic ring. The use of these materials in combination tends to achieve even higher heat resistance.

The adhesive composition preferably contains at least one polyol selected from the group consisting of a polyester polyol, an acrylic polyol, and a polycarbonate diol, from the viewpoint of achieving even higher heat resistance. Of these, a polyester polyol is more preferable from the viewpoint of achieving even higher heat resistance.

In the adhesive composition, the ratio (NCO/OH) of the number of isocyanate groups contained in the polyfunctional isocyanate compound to the number of hydroxyl groups contained in the polyol may be 1.5 to 40.0, or 15.0 to 30.0. When the ratio is 1.5 or more, a reaction of the curing agent occurs, and a by-product such as a urea resin or a biuret resin is more likely to be formed. An active hydrogen group contained in such a by-product interacts with a polar group of an adjacent layer and achieves higher interface adhesion, and this tends to lead to higher heat resistance. When the ratio is 40.0 or less, even higher lamination strength can be achieved under room temperature environmental conditions and high temperature environmental conditions.

The thickness of the first adhesive layer 12a is not particularly limited, but is preferably, for example, 1 to 10 μm, and more preferably 2 to 7 μm, from the viewpoint of obtaining desired adhesive strength, conformability, processability, and the like.

The mass per unit area of the first adhesive layer 12a may be 2.0 to 6.0 g/m², 2.5 to 5.0 g/m², or 3.0 to 4.0 g/m², from the viewpoint of ensuring higher lamination strength under both room temperature environmental conditions and high temperature environmental conditions and achieving better deep drawing formability.

### Primer Layer 17

### First Aspect

First, the primer layer 17 of the packaging material 10 according to the first aspect of the present embodiment will be described.

The primer layer 17 is provided to improve the adhesion between the first adhesive layer 12a and the barrier layer 13. The primer layer 17 may be composed of, for example, a primer layer forming composition containing a silane coupling agent (alkoxysilane), silazane, siloxane, or the like, and preferably composed of a primer layer forming composition containing a silane coupling agent.

In the primer layer 17, by X-ray photoelectron spectroscopy analysis of the surface of the primer layer 17 facing the first adhesive layer 12a, a peak P (Si) derived from Si 2p3/2 is detected in the range of 99 eV to 104 eV, and a peak P(N) derived from N1s is detected in the range of 396 eV to 404 eV. Furthermore, in the primer layer 17, an area ratio S (Si)/S (N) between a peak area S (Si) of the peak P (Si) and a peak area S (N) of the peak P(N) is 2.0 or less. The primer layer 17 that satisfies such conditions and is provided between the first adhesive layer 12a and the barrier layer 13 can improve the interface adhesion under high temperature environmental conditions, ensuring good lamination strength under both room temperature environmental conditions and high temperature environmental conditions.

The area ratio S (Si)/S (N) is 2.0 or less, and may be 1.8 or less, 1.5 or less, 1.2 or less, 1.0 or less, or 0.8 or less. When the area ratio S (Si)/S (N) is 2.0 or less, the primer layer 17 contains a sufficient number of functional groups, and a reaction between the functional groups in the primer layer 17 and reactive functional groups in the first adhesive layer 12a is more likely to sufficiently proceed, forming a sufficient number of covalent bonds between the first adhesive layer 12a and the primer layer 17, thus ensuring good lamination strength under both room temperature environmental conditions and high temperature environmental conditions. On the other hand, the lower limit of the area ratio S (Si)/S (N) is not particularly limited, and may be 0.1 or more, 0.2 or more, 0.3 or more, or 0.4 or more, from the viewpoint of achieving both good performance and low cost.

In the case where the barrier layer 13 is a metal foil made of aluminum or an aluminum alloy, in the primer layer 17, by X-ray photoelectron spectroscopy analysis of the surface of the primer layer 17 facing the first adhesive layer 12a, a peak P (Al) derived from Al 2p3/2 is preferably detected in the range of 70 eV to 78 eV. The peak P (Al) is a peak derived from the barrier layer 13, and detection of the peak means that the primer layer is a monomolecular film or a thin film of approximately 10 nm or less that is composed of a silane coupling agent or the like, from the resolution in the depth direction of the X-ray photoelectron spectroscopy. When the primer layer 17 is a monomolecular film or a thin film as described above, the primer layer 17 has higher interface adhesion to an adjacent layer, achieving higher heat resistance (lamination strength under high temperature environmental conditions). In the case where the primer layer 17 is a single-layer monomolecular film or thin film, cohesive failure of the primer layer 17 is less likely to occur as compared with the case where the primer layer 17 is a multilayer, thus achieving even higher heat resistance and initial adhesion.

The X-ray photoelectron spectroscopy (XPS) analysis of the surface of the primer layer 17 can be performed in the following manner. First, the substrate layer 11 is peeled off from the packaging material 10, and the first adhesive layer 12a is removed by etching or the like as necessary to expose the surface of the primer layer 17 facing the first adhesive layer 12a. The surface of the primer layer 17 after removal of the first adhesive layer 12a is analyzed under the following conditions using a photoelectron spectrometer. The photoelectron spectrometer may be, for example, a JPS-9030 (trade name) manufactured by JEOL Ltd., or the like, but is not particularly limited.
Incident X-rays: Mg Kα (non-monochromatic x-ray, hv=1253.6 eV)
X-ray output: 10 kV·10 mA (100 W)
Photoelectron capture angle: 90°
Measurement region: 6 mmφ
Peak shift correction: Correction is performed so that the maximum binding energy of the C1s peak is 285 eV.

The silane coupling agent used to form the primer layer 17 may be a compound having a functional group containing a nitrogen atom. Examples of the functional group containing a nitrogen atom include an amino group, an isocyanate group, a cyano group, an amide group, a urea group, and an azido group. Of these, an amino group and an isocyanate group are preferable from the viewpoint of achieving even higher lamination strength under high temperature environmental conditions. Silane coupling agents can be used singly or in combination of two or more. When two or more silane coupling agents are used in combination, silane coupling agents having different functional groups may be used in combination.

The primer layer 17 is preferably formed through a dehydration condensation reaction of a silane coupling agent. For example, an alkoxy group in the silane coupling agent may be hydrolyzed to form silanol groups, and a dehydration condensation reaction occurs between the silanol groups or between the silanol groups and hydroxyl groups on the surface of the barrier layer 13 or the first anticorrosion treatment layer 14a. The primer layer 17 formed through a dehydration condensation reaction of a silane coupling agent can achieve even higher lamination strength under both room temperature environmental conditions and high temperature environmental conditions.

The primer layer 17 can be formed by applying a primer layer forming composition onto a layer serving as a base, followed by curing. The primer layer forming composition can be prepared by diluting, to a predetermined concentration, a silane coupling agent or the like with a polar solvent such as an alcoholic solvent. The concentration (nonvolatile component concentration) of the silane coupling agent or the like is not particularly limited, and may be, for example, 0.05 to 3.0 mass %, or 0.5 to 1.5 mass %. Other than the silane coupling agent or the like and the solvent, the primer layer forming composition may contain a weakly acidic compound such as acetic acid or citric acid, a weakly basic compound such as ammonium hydroxide (ammonia water), or the like. The primer layer forming composition can be applied using a known method such as gravure direct coating, gravure reverse coating (direct coating, kiss coating), or micro gravure coating.

The primer layer 17 can be cured, for example, under conditions of 40 to 100° C. for 1.0 to 5.0 minutes. The curing is preferably performed before the barrier layer 13 and the substrate layer 11 are bonded to each other. In order to more sufficiently cure the primer layer 17, the primer layer 17 may be aged at room temperature to 100° C. for 1 to 10 days.

The area ratio S (Si)/S (N) in the primer layer 17 can be adjusted by varying the structure (the type, number, or molecular weight of functional groups, etc.) of a silane coupling agent or the like to be used, the concentration of a coating liquid, or the like.

The primer layer 17 preferably has a thickness of 30 nm or less, and more preferably 10 nm or less. When the thickness of the primer layer 17 is 30 nm or less, cohesive failure of the primer layer 17 is less likely to occur, thus achieving higher heat resistance (lamination strength under high temperature environmental conditions). The lower limit of the thickness of the primer layer 17 is not particularly limited, and may be, for example, 1.0 nm or more, from the viewpoint of allowing a reaction between the primer layer 17 and the barrier layer 13 and/or a reaction between the primer layer 17 and the first adhesive layer 12a to more sufficiently proceed.

### Second Aspect

Next, the primer layer 17 of the packaging material 100 according to the second aspect of the present embodiment will be described.

The primer layer 17 is provided to improve the adhesion between the second adhesive layer 12b and the barrier layer 13. The primer layer 17 may be composed of, for example, a primer layer forming composition containing a silane coupling agent (alkoxysilane), silazane, siloxane, or the like, and preferably composed of a primer layer forming composition containing a silane coupling agent.

In the primer layer 17, by X-ray photoelectron spectroscopy analysis of the surface of the primer layer 17 facing the second adhesive layer 12b, a peak P (Si) derived from Si 2p3/2 is detected in the range of 99 eV to 104 eV, and a peak P(N) derived from N1s is detected in the range of 396 eV to 404 eV. Furthermore, in the primer layer 17, an area ratio S (Si)/S (N) between a peak area S (Si) of the peak P (Si) and a peak area S (N) of the peak P(N) is 2.0 or less. The primer layer 17 that satisfies such conditions and is provided between the second adhesive layer 12b and the barrier layer 13 can improve the interface adhesion under high temperature environmental conditions, ensuring good heat sealing strength under both room temperature environmental conditions and high temperature environmental conditions.

The area ratio S (Si)/S (N) is 2.0 or less, and may be 1.8 or less, 1.5 or less, 1.2 or less, 1.0 or less, or 0.8 or less. When the area ratio S (Si)/S (N) is 2.0 or less, the primer layer 17 contains a sufficient number of functional groups, and a reaction between the functional groups in the primer layer 17 and reactive functional groups in the second adhesive layer 12b is more likely to sufficiently proceed, forming a sufficient number of covalent bonds between the second adhesive layer 12b and the primer layer 17, thus ensuring good heat sealing strength under both room temperature environmental conditions and high temperature environmental conditions. On the other hand, the lower limit of the area ratio S (Si)/S (N) is not particularly limited, and may be 0.1 or more, 0.2 or more, 0.3 or more, or 0.4 or more, from the viewpoint of achieving both good performance and low cost.

In the case where the barrier layer 13 is a metal foil made of aluminum or an aluminum alloy, in the primer layer 17, by X-ray photoelectron spectroscopy analysis of the surface of the primer layer 17 facing the second adhesive layer 12b, a peak P (Al) derived from Al 2p3/2 is preferably detected in the range of 70 eV to 78 eV. The peak P (Al) is a peak derived from the barrier layer 13, and detection of the peak means that the primer layer is a monomolecular film or a thin film of approximately 10 nm or less that is composed of a silane coupling agent or the like, from the resolution in the depth direction of the X-ray photoelectron spectroscopy. When the primer layer 17 is a monomolecular film or a thin film as described above, the primer layer 17 has higher interface adhesion to an adjacent layer, achieving higher heat resistance (heat sealing strength under high temperature environmental conditions). In the case where the primer layer 17 is a single-layer monomolecular film or thin film, cohesive failure of the primer layer 17 is less likely to occur as compared with the case where the primer layer 17 is a multilayer, thus achieving even higher heat resistance and initial adhesion.

The X-ray photoelectron spectroscopy (XPS) analysis of the surface of the primer layer 17 can be performed in the following manner. First, the sealant layer 16 is peeled off from the packaging material 100, and the second adhesive layer 12b is removed by etching or the like as necessary to expose the surface of the primer layer 17 facing the second adhesive layer 12b. The surface of the primer layer 17 after removal of the second adhesive layer 12b is analyzed under the following conditions using a photoelectron spectrometer. The photoelectron spectrometer may be, for example, a JPS-9030 (trade name) manufactured by JEOL Ltd., or the like, but is not particularly limited.
Incident X-rays: Mg Kα (non-monochromatic x-ray, hv=1253.6 eV)
X-ray output: 10 kV·10 mA (100 W)
Photoelectron capture angle: 90°
Measurement region: 6 mmφ
Peak shift correction: Correction is performed so that the maximum binding energy of the C1s peak is 285 eV.

The silane coupling agent used to form the primer layer 17 may be a compound having a functional group containing a nitrogen atom. Examples of the functional group containing a nitrogen atom include an amino group, an isocyanate group, a cyano group, an amide group, a urea group, and an azido group. Of these, an amino group and an isocyanate group are preferable, and an amino group is more preferable, from the viewpoint of achieving even higher heat sealing strength under high temperature environmental conditions. The spacer chain of the silane coupling agent may be 0 to 50, preferably 1 to 30, and more preferably 3 to 15, from the viewpoint of adhesion (heat sealing strength). Silane coupling agents can be used singly or in combination of two or more. When two or more silane coupling agents are used in combination, silane coupling agents having different functional groups may be used in combination.

The primer layer 17 is preferably formed through a dehydration condensation reaction of a silane coupling agent. For example, an alkoxy group in the silane coupling agent is hydrolyzed to form silanol groups, and a dehydration condensation reaction occurs between the silanol groups or between the silanol groups and hydroxyl groups on the surface of the barrier layer 13 or the second anticorrosion treatment layer 14b. The primer layer 17 formed through a dehydration condensation reaction of a silane coupling agent can achieve even higher heat sealing strength under both room temperature environmental conditions and high temperature environmental conditions.

The primer layer 17 can be formed by applying a primer layer forming composition onto a layer serving as a base, followed by curing. The primer layer forming composition can be prepared by diluting, to a predetermined concentration, a silane coupling agent or the like with a polar solvent such as an alcoholic solvent. The concentration (nonvolatile component concentration) of the silane coupling agent or the like is not particularly limited, and may be, for example, 0.05 to 3.0 mass %, or 0.5 to 1.5 mass %. Other than the silane coupling agent or the like and the solvent, the primer layer forming composition may contain a weakly acidic compound such as acetic acid or citric acid, a weakly basic compound such as ammonium hydroxide (ammonia water), or the like. The primer layer forming composition can be applied using a known method such as gravure direct coating, gravure reverse coating (direct coating, kiss coating), or micro gravure coating.

The primer layer 17 can be cured, for example, under conditions of 40 to 100° C. for 1.0 to 5.0 minutes. The curing is preferably performed before the barrier layer 13 and the second adhesive layer 12b are bonded to each other. In order to more sufficiently cure the primer layer 17, the primer layer 17 may be aged at room temperature to 100° C. for 1 to 10 days.

The area ratio S (Si)/S (N) in the primer layer 17 can be adjusted by varying the structure (the type, number, or molecular weight of functional groups, etc.) of a silane coupling agent or the like to be used, the concentration of a coating liquid, or the like.

The primer layer 17 preferably has a thickness of 30 nm or less, and more preferably 10 nm or less. When the thickness of the primer layer 17 is 30 nm or less, cohesive failure of the primer layer 17 is less likely to occur, thus achieving higher heat resistance (heat sealing strength under high temperature environmental conditions). The lower limit of the thickness of the primer layer 17 is not particularly limited, and may be, for example, 1.0 nm or more, from the viewpoint of allowing a reaction between the primer layer 17 and the barrier layer 13 and/or a reaction between the primer layer 17 and the second adhesive layer 12b to more sufficiently proceed.

### Barrier Layer 13

The barrier layer 13 has water vapor barrier properties to prevent moisture from penetrating into the power storage device. The barrier layer 13 may have ductility for deep drawing. The barrier layer 13 may be, for example, various types of metal foil such as an aluminum foil, a stainless steel foil, or a copper foil, or a metal vapor deposition film, an inorganic oxide vapor deposition film, a carbon-containing inorganic oxide vapor deposition film, a film provided with such a vapor deposition film, or the like. The film provided with a vapor deposition film may be, for example, an aluminum vapor deposition film, or an inorganic oxide vapor deposition film. These can be used singly or in combination of two or more. The barrier layer 13 is preferably a metal foil, and more preferably an aluminum foil, in terms of mass (specific gravity), moisture resistance, processability, and cost.

The aluminum foil may be preferably an annealed soft aluminum foil, in particular, from the viewpoint of obtaining desired ductility during forming. However, the aluminum foil is more preferably an aluminum foil containing iron (aluminum alloy foil), for the purpose of obtaining further pinhole resistance and ductility during forming. The iron content in the aluminum foil is preferably 0.1 to 9.0 mass %, and more preferably 0.5 to 2.0 mass %, with respect to 100 mass % of aluminum foil. When the iron content is 0.1 mass % or more, the packaging materials 10 and 100 can have higher pinhole resistance and ductility. When the iron content is 9.0 mass % or less, the packaging materials 10 and 100 can have higher flexibility. The aluminum foil may be an untreated aluminum foil, but is preferably a degreased aluminum foil from the viewpoint of obtaining corrosion resistance. When the aluminum foil is degreased, only one surface of the aluminum foil may be degreased, or both surfaces of the aluminum foil may be degreased.

The thickness of the barrier layer 13 is not particularly limited, but is preferably 9 to 200 μm, and more preferably 15 to 100 μm, considering barrier properties, pinhole resistance, and processability.

### First Anticorrosion Treatment Layer 14a and Second Anticorrosion Treatment Layer 14b

The first anticorrosion treatment layer 14a and the second anticorrosion treatment layer 14b are provided to prevent corrosion of the metal foil (metal foil layer) or the like constituting the barrier layer 13. The first anticorrosion treatment layer 14a improves the adhesion between the barrier layer 13 and the first adhesive layer 12a. The second anticorrosion treatment layer 14b improves the adhesion between the barrier layer 13 and the second adhesive layer 12b. The first anticorrosion treatment layer 14a and the second anticorrosion treatment layer 14b may have the same configuration or different configurations. The first anticorrosion treatment layer 14a and the second anticorrosion treatment layer 14b (hereinafter also simply referred to as “anticorrosion treatment layers 14a and 14b”) are formed, for example, by degreasing treatment, hydrothermal conversion treatment, anodic oxidation treatment, chemical conversion treatment, or a combination of these treatments.

Examples of the degreasing treatment include acid degreasing treatment and alkaline degreasing treatment. In the acid degreasing treatment, an inorganic acid such as sulfuric acid, nitric acid, hydrochloric acid, or hydrofluoric acid may be used singly or as a mixture. The acid degreasing treatment using an acid degreasing agent obtained by dissolving a fluorine-containing compound such as monosodium ammonium difluoride in the inorganic acid is effective in terms of corrosion resistance in particular when the barrier layer 13 is composed of an aluminum foil because it is possible not only to obtain the effect of degreasing aluminum but also to form a fluoride of aluminum in a passive state. In the alkaline degreasing treatment, sodium hydroxide or the like may be used.

Examples of the hydrothermal conversion treatment include boehmite treatment in which an aluminum foil is immersed in boiling water containing triethanolamine. Examples of the anodic oxidation treatment include alumite treatment.

The chemical conversion treatment may be an immersion-type chemical conversion treatment or a coating-type chemical conversion treatment. Examples of the immersion-type chemical conversion treatment include chromate treatment, zirconium treatment, titanium treatment, vanadium treatment, molybdenum treatment, calcium phosphate treatment, strontium hydroxide treatment, cerium treatment, ruthenium treatment, and various chemical conversion treatments using mixed phases of these materials. Examples of the coating-type chemical conversion treatment include a treatment in which a coating agent having anticorrosion properties is applied onto the barrier layer 13.

Of these anticorrosion treatments, before any of the hydrothermal conversion treatment, the anodic oxidation treatment, and the chemical conversion treatment is performed to form at least part of the anticorrosion treatment layers, it is preferable to perform the aforementioned degreasing treatment in advance. When the barrier layer 13 is composed of a degreased metal foil such as an annealed metal foil, no degreasing treatment is required to form the anticorrosion treatment layers 14a and 14b.

The coating agent used for the coating-type chemical conversion treatment preferably contains trivalent chromium. The coating agent may contain at least one polymer selected from the group consisting of a cationic polymer and an anionic polymer described later.

Of the treatments described above, in the hydrothermal conversion treatment and the anodic oxidation treatment in particular, the surface of an aluminum foil is dissolved with a treatment agent to form an aluminum compound (boehmite or alumite) having high corrosion resistance. Thus, a co-continuous structure extending from the barrier layer 13 composed of an aluminum foil to the anticorrosion treatment layers 14a and 14b is formed, and these treatments are therefore included in the definition of chemical conversion treatment. However, as described later, the anticorrosion treatment layers 14a and 14b can be formed only by a pure coating method that is not included in the definition of chemical conversion treatment. In such a coating method, for example, a sol of a rare-earth element oxide such as cerium oxide with an average particle size of 100 nm or less may be used as a material that has an anticorrosion effect (inhibitor effect) for aluminum and is preferable in terms of environmental aspects. The use of such a rare-earth element oxide sol allows a metal foil such as an aluminum foil to have an anticorrosion effect even when a typical coating method is used.

Examples of the rare-earth element oxide sol include sols containing various solvents such as an aqueous solvent, an alcoholic solvent, a hydrocarbon solvent, a ketone solvent, an ester solvent, or an ether solvent. Of these, an aqueous sol is preferable.

To stabilize dispersion of the rare-earth element oxide sol, the rare-earth element oxide sol typically contains, as a dispersion stabilizer, an inorganic acid such as nitric acid, hydrochloric acid, or phosphoric acid, or a salt thereof, or an organic acid such as acetic acid, malic acid, ascorbic acid, or lactic acid. Of these dispersion stabilizers, phosphoric acid in particular is expected to achieve, in the packaging materials 10 and 100, (1) stabilized dispersion of the sol, (2) higher adhesion to the barrier layer 13 due to the aluminum chelating ability of the phosphoric acid, (3) corrosion resistance obtained by capturing aluminum ions eluted under the influence of acid or corrosive gas (passivation), (4) a higher cohesive force of the anticorrosion treatment layers (oxide layers) 14a and 14b due to easy occurrence of dehydration condensation of the phosphoric acid at low temperature, and the like.

The anticorrosion treatment layers 14a and 14b composed of the rare-earth element oxide sol are an aggregate of inorganic particles, and this may cause the layers to have a low cohesive force even after dry curing. Thus, in such a case, in order to compensate the cohesive force, the anticorrosion treatment layers 14a and 14b are preferably combined with an anionic polymer or a cationic polymer to form a composite layer.

The anticorrosion treatment layers 14a and 14b are not limited to the layers described above. For example, the anticorrosion treatment layers 14a and 14b may be formed using a treatment agent obtained by adding phosphoric acid and a chromium compound to a resin binder (aminophenol, etc.), as in a coating-type chromate treatment that is a known technique. The use of the treatment agent allows the layers to have both corrosion resistance and adhesion. Alternatively, layers having both corrosion resistance and adhesion can be obtained using a coating agent prepared in advance by combining a rare-earth element oxide sol with a polycationic polymer or a polyanionic polymer, although the stability of the coating agent needs to be considered.

Regardless of whether the anticorrosion treatment layers 14a and 14b have a multilayer structure or a single-layer structure, the mass per unit area of the anticorrosion treatment layers 14a and 14b is preferably 0.005 to 0.200 g/m², and more preferably 0.010 to 0.100 g/m². When the mass per unit area is 0.005 g/m² or more, the barrier layer 13 is more likely to have corrosion resistance. Even if the mass per unit area exceeds 0.200 g/m², there is little change in the corrosion resistance. When a rare-earth element oxide sol is used and the coating is thick, thermal curing during drying may be insufficient, causing a lower cohesive force. The thickness of the anticorrosion treatment layers 14a and 14b can be converted from the specific gravity of the anticorrosion treatment layers 14a and 14b.

From the viewpoint that the adhesion between the sealant layer and the barrier layer is more likely to be maintained, for example, the anticorrosion treatment layers 14a and 14b may contain cerium oxide, 1 to 100 parts by mass of phosphoric acid or phosphate with respect to 100 parts by mass of the cerium oxide, and a cationic polymer, or may be formed by applying chemical conversion treatment to the barrier layer 13, or may be formed by applying chemical conversion treatment to the barrier layer 13 and contain a cationic polymer.

### Second Adhesive Layer 12b

The second adhesive layer 12b adheres the barrier layer 13 to the sealant layer 16. The second adhesive layer 12b may be composed of a typical adhesive for adhering the barrier layer 13 to the sealant layer 16.

In the case where the second anticorrosion treatment layer 14b is provided on the barrier layer 13 and includes a layer containing at least one polymer selected from the group consisting of a cationic polymer and an anionic polymer described above, the second adhesive layer 12b preferably contains a compound (hereinafter also referred to as a “reactive compound”) having reactivity with the polymer contained in the second anticorrosion treatment layer 14b.

For example, when the second anticorrosion treatment layer 14b contains a cationic polymer, the second adhesive layer 12b preferably contains a compound having reactivity with the cationic polymer. When the second anticorrosion treatment layer 14b contains an anionic polymer, the second adhesive layer 12b preferably contains a compound having reactivity with the anionic polymer. When the second anticorrosion treatment layer 14b contains a cationic polymer and an anionic polymer, the second adhesive layer 12b preferably contains a compound having reactivity with the cationic polymer and a compound having reactivity with the anionic polymer. However, the second adhesive layer 12b may not necessarily contain the two types of compounds, and may contain a compound having reactivity with both the cationic polymer and the anionic polymer. The phrase “having reactivity” refers to forming a covalent bond with a cationic polymer or an anionic polymer. The second adhesive layer 12b may further contain an acid-modified polyolefin resin.

The compound having reactivity with a cationic polymer may be at least one compound selected from the group consisting of a polyfunctional isocyanate compound, a glycidyl compound, a compound having a carboxy group, and a compound having an oxazoline group.

The polyfunctional isocyanate compound, the glycidyl compound, the compound having a carboxy group, and the compound having an oxazoline group may be a polyfunctional isocyanate compound, a glycidyl compound, a compound having a carboxy group, and a compound having an oxazoline group described above as a crosslinking agent for allowing a cationic polymer to have a crosslinked structure. Of these, a polyfunctional isocyanate compound is preferable in terms of high reactivity with a cationic polymer and easy formation of a crosslinked structure.

The compound having reactivity with an anionic polymer may be at least one compound selected from the group consisting of a glycidyl compound, and a compound having an oxazoline group. The glycidyl compound and the compound having an oxazoline group may be a glycidyl compound and a compound having an oxazoline group described above as a crosslinking agent for allowing a cationic polymer to have a crosslinked structure. Of these, a glycidyl compound is preferable in terms of high reactivity with an anionic polymer.

When the second adhesive layer 12b contains an acid-modified polyolefin resin, the reactive compound preferably also has reactivity with an acidic group (i.e., forms a covalent bond with an acidic group) in the acid-modified polyolefin resin. This allows the second adhesive layer 12b to have higher adhesion to the second anticorrosion treatment layer 14b. In addition, this enables the acid-modified polyolefin resin to have a crosslinked structure, allowing the packaging materials 10 and 100 to have even higher solvent resistance.

The reactive compound content is preferably 1 to 10 equivalents relative to the acidic group in the acid-modified polyolefin resin. When the reactive compound content is 1 or more equivalents, the reactive compound sufficiently reacts with the acidic group in the acid-modified polyolefin resin. If the reactive compound content exceeds 10 equivalents, a crosslinking reaction with the acid-modified polyolefin resin is sufficiently saturated, and thus the presence of unreacted material may lead to deterioration in various performances. Therefore, for example, the reactive compound content is preferably 5 to 20 parts by mass (solid content ratio) with respect to 100 parts by mass of acid-modified polyolefin resin.

The acid-modified polyolefin resin is obtained by introducing an acidic group into a polyolefin resin. The acidic group may be a carboxy group, a sulfonic acid group, an acid anhydride group, or the like, and is particularly preferably a maleic anhydride group, a (meth)acryl group, or the like. The acid-modified polyolefin resin may be, for example, similar to a modified polyolefin resin used to form the sealant layer 16.

The second adhesive layer 12b may contain various additives such as a flame retardant, a slip agent, an anti-blocking agent, an antioxidant, a photostabilizer, and a tackifier.

The second adhesive layer 12b may contain, for example, acid-modified polyolefin, and at least one curing agent selected from the group consisting of a polyfunctional isocyanate compound, a glycidyl compound, a compound having a carboxy group, a compound having an oxazoline group, and a carbodiimide compound, from the viewpoint of preventing reduction in lamination strength and heat sealing strength when corrosive gas such as hydrogen sulfide or an electrolyte solution is involved and the viewpoint of further preventing reduction in insulating properties. Examples of the carbodiimide compound include N,N′-di-o-tolylcarbodiimide, N,N′-diphenylcarbodiimide, N,N′-di-2,6-dimethylphenylcarbodiimide, N,N′-bis(2,6-diisopropylphenyl)carbodiimide, N,N′-dioctyldecylcarbodiimide, N-tolyl-N′-cyclohexylcarbodiimide, N,N′-di-2,2-di-t-butylphenylcarbodiimide, N-triyl-N′-phenylcarbodiimide, N,N′-di-p-nitrophenylcarbodiimide, N,N′-di-p-aminophenylcarbodiimide, N,N′-di-p-hydroxyphenylcarbodiimide, N,N′-di-cyclohexylcarbodiimide, and N,N′-di-p-tolylcarbodiimide.

The adhesive for forming the second adhesive layer 12b may be, for example, a polyurethane adhesive containing polyisocyanate and polyester polyol composed of hydrogenated dimer fatty acid and diol. The adhesive may be a polyurethane resin obtained by allowing a bi- or higher-functional isocyanate compound to act on a base resin such as a polyester polyol, a polyether polyol, an acrylic polyol, or a carbonate polyol, or an epoxy resin obtained by allowing an amine compound or the like to act on a base resin having an epoxy group, and these resins are preferable from the viewpoint of heat resistance.

The thickness of the second adhesive layer 12b is not particularly limited, but is preferably 1 to 10 μm, and more preferably 2 to 7 μm, from the viewpoint of obtaining desired adhesive strength, processability, and the like.

### Sealant Layer 16

The sealant layer 16 imparts sealability by heat sealing to the packaging materials 10 and 100, and during assembly of the power storage device, the sealant layer 16 is located on the inner side and heat-sealed. The sealant layer 16 may be a resin film composed of a polyolefin resin or a polyester resin. Such resins (hereinafter also referred to as “base resins”) constituting the sealant layer 16 may be used singly or in combination of two or more.

Examples of the polyolefin resin include low, medium, and high-density polyethylene, an ethylene-α-olefin copolymer, polypropylene, block and random copolymers containing propylene as a copolymerization component, and a propylene-α-olefin copolymer.

Examples of the polyester resin include a polyethylene terephthalate (PET) resin, a polybutylene terephthalate (PBT) resin, a polyethylene naphthalate (PEN) resin, a polybutylene naphthalate (PBN) resin, and a polytrimethylene terephthalate (PTT) resin.

The sealant layer 16 may contain a polyolefin elastomer. The polyolefin elastomer may or may not have compatibility with the base resin described above, and may contain both a compatible polyolefin elastomer having compatibility with the base resin and an incompatible polyolefin elastomer having no compatibility with the base resin. A material having compatibility (compatible material) with a base resin refers to a material dispersed with a dispersed phase size of 1 nm or more and less than 500 nm in the base resin. A material having no compatibility (incompatible material) with a base resin refers to a material dispersed with a dispersed phase size of 500 nm or more and less than 20 μm in the base resin.

When the base resin is a polypropylene resin, the compatible polyolefin elastomer may be, for example, a propylene-butene-1 random copolymer, and the incompatible polyolefin elastomer may be, for example, an ethylene-butene-1 random copolymer. Polyolefin elastomers can be used singly or in combination of two or more.

The sealant layer 16 may contain, as an additive component, for example, a slip agent, an anti-blocking agent, an antioxidant, a photostabilizer, a crystal nucleating agent, a flame retardant, and the like. The content of such an additive component is preferably 5 parts by mass or less when the total mass of the sealant layer 16 is 100 parts by mass.

The thickness of the sealant layer 16 is not particularly limited, but is preferably in the range of 5 to 100 μm, more preferably in the range of 10 to 100 μm, and still more preferably in the range of 20 to 80 μm, from the viewpoint of achieving both a small thickness and higher heat sealing strength under high temperature environmental conditions.

The sealant layer 16 may be a single-layer film or a multilayer film. The sealant layer 16 may be formed as a single-layer film or a multilayer film, according to the required function.

The melting peak temperature of the sealant layer 16 varies depending on the intended use of the packaging material, and in a packaging material for an all-solid-state battery, the melting peak temperature of the sealant layer 16 is preferably 160 to 280° C. because in such a case, higher heat resistance is achieved.

Preferred embodiments of the power storage device packaging material of the present embodiment have been described in detail. However, the present disclosure is not limited to such specific embodiments, and may be variously modified and changed within the spirit of the present disclosure recited in the claims.

For example, FIGS. 1 and 3 show the power storage device packaging materials in which the anticorrosion treatment layers 14a and 14b are provided on the respective surfaces of the barrier layer 13. However, only one of the anticorrosion treatment layers 14a and 14b may be provided, or no anticorrosion treatment layer may be provided.

The power storage device packaging material according to the first aspect of the present disclosure may include the primer layer 17 not only at the position between the barrier layer 13 and the first adhesive layer 12a but also at a position between layers on the side closer to the sealant layer 16 than the barrier layer 13. In such a case, the power storage device packaging material can have higher heat sealing strength. The primer layer 17 can be provided at least one of the position between the anticorrosion treatment layer 14b and the second adhesive layer 12b or an adhesive resin layer 15 (described later) and the position between the second adhesive layer 12b or the adhesive resin layer 15 (described later) and the sealant layer 16, but is preferably provided at the position between the anticorrosion treatment layer 14b and the second adhesive layer 12b or the adhesive resin layer 15 (described later), because in such a case, the packaging material is more likely to have higher heat sealing strength.

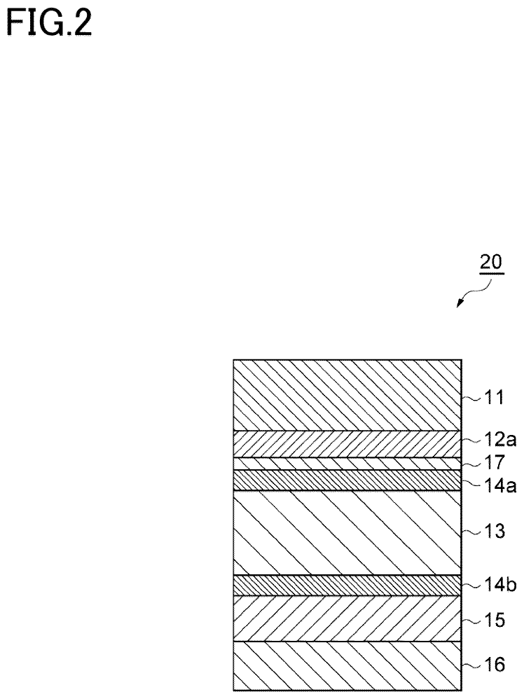

FIG. 1 shows the power storage device packaging material in which the second adhesive layer 12b is used to laminate the barrier layer 13 and the sealant layer 16. However, the adhesive resin layer 15 may be used to laminate the barrier layer 13 and the sealant layer 16, as in a power storage device packaging material 20 shown in FIG. 2. In the power storage device packaging material 20 shown in FIG. 2, the second adhesive layer 12b may be provided between the barrier layer 13 and the adhesive resin layer 15.

The power storage device packaging material according to the second aspect of the present disclosure may include the primer layer 17 at least one of positions between layers from the barrier layer 13 to the sealant layer 16. Thus, the primer layer 17 may be provided not at the position between the barrier layer 13 and the second adhesive layer 12b but at the position between the second adhesive layer 12b and the sealant layer 16. The primer layer 17 may be provided at both of the position between the barrier layer 13 and the second adhesive layer 12b and the position between the second adhesive layer 12b and the sealant layer 16.

The power storage device packaging material according to the second aspect of the present disclosure may include the primer layer 17 not only at a position between layers from the barrier layer 13 to the sealant layer 16 but also at a position between layers on the side closer to the substrate layer 11 than the barrier layer 13. In such a case, the power storage device packaging material can have higher lamination strength. In this case, the primer layer 17 can be provided between the anticorrosion treatment layer 14a and the first adhesive layer 12a.

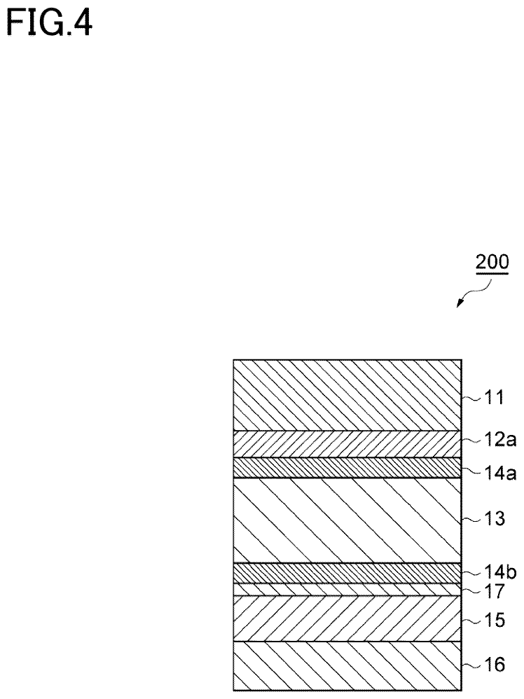

FIG. 3 shows the power storage device packaging material in which the second adhesive layer 12b is used to laminate the barrier layer 13 and the sealant layer 16. However, the adhesive resin layer 15 may be used to laminate the barrier layer 13 and the sealant layer 16, as in a power storage device packaging material 200 shown in FIG. 4. In the power storage device packaging material 200 shown in FIG. 4, the primer layer 17 is provided between the second anticorrosion treatment layer 14b and the adhesive resin layer 15. However, the primer layer 17 may be provided between the adhesive resin layer 15 and the sealant layer 16. In the power storage device packaging material 200 shown in FIG. 4, the second adhesive layer 12b may be provided between the barrier layer 13 and the adhesive resin layer 15.

### Adhesive Resin Layer 15

The adhesive resin layer 15 contains an adhesive resin composition as a main component, and if necessary, an additive component. The adhesive resin composition is not particularly limited, but preferably contains a modified polyolefin resin.

The modified polyolefin resin is preferably a polyolefin resin graft modified with an unsaturated carboxylic acid derivative derived from any of an unsaturated carboxylic acid, an acid anhydride thereof, and an ester thereof.

Examples of the polyolefin resin include low-density polyethylene, medium-density polyethylene, high-density polyethylene, an ethylene-α-olefin copolymer, homopolypropylene, block polypropylene, random polypropylene, and a propylene-α-olefin copolymer.

The modified polyolefin resin is preferably a polyolefin resin modified with maleic anhydride. Examples of suitable modified polyolefin resins include “Admer” manufactured by Mitsui Chemicals, Inc., and “Modic” manufactured by Mitsubishi Chemical Corporation. Such a modified polyolefin resin has high reactivity with various metals and polymers having various functional groups, and the reactivity allows the adhesive resin layer 15 to have adhesion, achieving higher electrolyte solution resistance. If necessary, the adhesive resin layer 15 may contain, for example, various additives such as various compatible and incompatible elastomers, flame retardants, slip agents, anti-blocking agents, antioxidants, photostabilizers, crystal nucleating agents, and tackifiers.

The thickness of the adhesive resin layer 15 is not particularly limited, but is preferably less than or equal to that of the sealant layer 16, from the viewpoint of stress relaxation and transmission of water and an electrolyte solution. From the above viewpoint, the thickness ratio between the adhesive resin layer 15 and the sealant layer 16 (the thickness of the adhesive resin layer 15/the thickness of the sealant layer 16) is preferably 0.06 to 1, more preferably 0.1 to 0.9, still more preferably 0.2 to 0.8, and particularly preferably 0.4 to 0.6. When the thickness ratio is not more than the upper limit, the sealant layer 16 is more likely to ensure adhesion during heat sealing, achieving even higher heat sealing strength in the initial stage (under room temperature environmental conditions) and at high temperature. When the thickness ratio is not less than the lower limit, it is possible to prevent the sealant layer 16 having a large thickness from causing a lower cohesive force, achieving even higher heat sealing strength in the initial stage (under room temperature environmental conditions) and at high temperature.

In the power storage device packaging material 20, the total thickness of the adhesive resin layer 15 and the sealant layer 16 is preferably in the range of 5 to 100 μm, and more preferably in the range of 20 to 80 μm, from the viewpoint of achieving both a small thickness and higher heat sealing strength under high temperature environmental conditions.

As in the power storage device packaging materials 20 and 200, in the packaging material including the adhesive resin layer 15 and the sealant layer 16, the adhesive resin layer 15 and the sealant layer 16 may be laminated by preparing resin compositions for forming the respective layers and laminating the resin compositions using a T-die method or an inflation method, or by forming a first layer and then extruding a second layer onto the first layer, or by forming layers using a T-die method or an inflation method and then bonding the layers to each other with an adhesive. The adhesive may be an adhesive containing acid-modified polypropylene and a curing agent (e.g., isocyanate, etc.), from the viewpoint of interface adhesion.

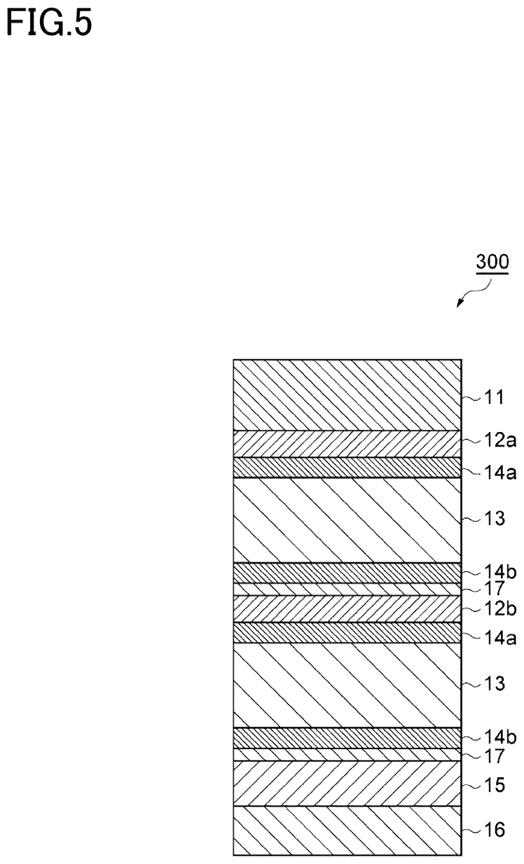

As with a power storage device packaging material 300 shown in FIG. 5, the power storage device packaging material according to the present embodiment may be a laminate that has the same configuration from the substrate layer 11 to the second adhesive layer 12b as the laminate shown in FIG. 3 and in which, on a surface of the second adhesive layer 12b, a barrier layer 13 having anticorrosion treatment layers (first anticorrosion treatment layer 14a and second anticorrosion treatment layer 14b) on the respective surfaces thereof, a primer layer 17 provided on the side of the barrier layer 13 facing away from the second adhesive layer 12b, the adhesive resin layer 15 provided on the side of the primer layer 17 facing away from the barrier layer 13, and the sealant layer 16 provided on the side of the adhesive resin layer 15 facing away from the primer layer 17 are laminated. The layers of the power storage device packaging material 300 may have the same configuration as the layers of the power storage device packaging material 100 shown in FIG. 3 and the power storage device packaging material 200 shown in FIG. 4. In the power storage device packaging material 300, the anticorrosion treatment layers 14a and 14b are provided on the respective surfaces of each of the two barrier layers 13; however, an anticorrosion treatment layer may be provided on only one of the surfaces of each of the barrier layers 13, or may not necessarily be provided. Instead of the adhesive resin layer 15, a second adhesive layer 12b may be provided. Furthermore, the primer layer 17 may be provided between the second adhesive layer 12b and the first anticorrosion treatment layer 14a.

The power storage device packaging material 300 includes two barrier layers, and thus can have better barrier properties. As compared with a power storage device packaging material including a single thick barrier layer, the power storage device packaging material including two barrier layer in combination can have better rigidity and stress dispersibility, achieving even higher mechanical strength of the packaging material. Even when the power storage device packaging material includes such a plurality of barrier layers, the primer layer 17 provided in the power storage device packaging material can improve the adhesion between the layers, ensuring good heat sealing strength under both room temperature environmental conditions and high temperature environmental conditions.

### Long-Chain Branched Polypropylene

In the packaging materials 10, 20, 100, 200, and 300 of the present embodiment, one or both of the adhesive resin layer 15 and the sealant layer 16 preferably contain long-chain branched polypropylene. When long-chain branched polypropylene is contained in the adhesive resin layer 15 and the sealant layer 16, the entanglement of resin in the layers becomes strong under high temperature environmental conditions, achieving even higher heat resistance. In the packaging material including the adhesive resin layer 15, polypropylene is preferably contained in both the adhesive resin layer 15 and the sealant layer 16, and from the viewpoint of achieving even higher heat resistance, long-chain branched polypropylene is preferably contained in at least the adhesive resin layer 15, and particularly preferably contained in both the adhesive resin layer 15 and the sealant layer 16.

The long-chain branched polypropylene has branched chains separate from the main chain. The long-chain branched polypropylene may be, for example, the materials described in JP 2009-275207 A or JP 2011-144356 A.

The number of carbon atoms in the branched chains of the long-chain branched polypropylene is preferably 500 or more, more preferably 10,000 or more, still more preferably 20,000 or more, and particularly preferably 40,000 or more, from the viewpoint of achieving even higher heat resistance. The branched chains of the long-chain branched polypropylene preferably have, for example, a structural unit derived from propylene. The long-chain branched polypropylene preferably does not have a three-dimensional network structure such as a crosslinked structure. The presence or absence of long-chain branching in the long-chain branched polypropylene can be measured, for example, from the radius of gyration for each molecular weight by GPC-MALS. The weight average molecular weight of the long-chain branched polypropylene is, for example, preferably 50,000 to 1,000,000, and more preferably 100,000 to 800,000. The weight average molecular weight can be measured by GPC.

The presence or absence of a branched structure of the long-chain branched polypropylene can be analyzed, for example, by applying the analysis described in paragraph [0093] and the subsequent description of JP 2011-144356 A. The branched structure (e.g., branching index) of the long-chain branched polyproplyene can be presumably specified, for example, from the difference in radius of gyration between a branched polymer and a linear polymer having the same molecular weight. For example, also in a mixed resin obtained by blending a branched polymer and a linear polymer, the branched structure of the branched polymer can be presumably estimated from the molecular weight of the branched polymer and the linear polymer, the radius of gyration of the mixed resin, and the radius of gyration of the linear polymer. For example, the radius of gyration of a mixed resin of a branched polymer and a linear polymer is presumably smaller than the radius of gyration of a linear polymer having the same molecular weight as the mixed resin. The radius of gyration can also be estimated, for example, from the intrinsic viscosity.

Long-chain branched polypropylene is a polymer having a structural unit derived from propylene. Examples of the long-chain branched polypropylene include homopolypropylene, random polypropylene (propylene-ethylene random copolymer), block polypropylene, and a copolymer (propylene copolymer) of propylene and a-olefin other than ethylene and propylene. Of these, homopolypropylene is preferable. The long-chain branched polypropylene may be acid-modified. When the long-chain branched polypropylene includes a structural unit other than the structure derived from propylene, the branched chains may be branched from a portion other than the structure derived from propylene.

In the packaging material, the content of long-chain branched polypropylene is preferably 0.5 to 30 mass %, more preferably 2.5 to 15 mass %, and still more preferably 5.0 to 10 mass %, with respect to the total amount of resin in the adhesive resin layer 15 and the sealant layer 16. When the content is 0.5 mass % or more, the entanglement of resin is increased, enhancing the effect of achieving higher heat resistance. When the content is 30 mass % or less, it is possible to prevent the packaging material from having lower heat sealing strength in the initial stage (under room temperature environmental conditions) and at high temperature. This is presumably because the long-chain branched polypropylene content of 30 mass % or less can prevent the entanglement of resin from becoming excessively large and causing lower fluidity of the resin. When the packaging material is heat-sealed, the lower fluidity of the resin may inhibit an accumulation of resin that contributes to higher sealing strength from being formed near the inner edge of the sealed portion. However, presumably, when the long-chain branched polypropylene content is 30 mass % or less, the formation of an accumulation of resin is not inhibited.

When the adhesive resin layer 15 contains long-chain branched polypropylene, the content of long-chain branched polypropylene is preferably 0.5 to 30 mass %, more preferably 2.5 to 15 mass %, and still more preferably 5.0 to 10 mass %, with respect to the total amount of resin in the adhesive resin layer 15. When the sealant layer 16 contains long-chain branched polypropylene, the content of long-chain branched polypropylene is preferably 0.5 to 30 mass %, more preferably 2.5 to 15 mass %, and still more preferably 5.0 to 10 mass %, with respect to the total amount of resin in the sealant layer 16. When the long-chain branched polypropylene content in the layers is 0.5 mass % or more, the entanglement of resin becomes large, enhancing the effect of achieving higher heat resistance. When the content is 30 mass % or less, it is possible to prevent the packaging material from having lower heat sealing strength in the initial stage (under room temperature environmental conditions) and at high temperature.

The resin in the adhesive resin layer 15 and the sealant layer 16 can be analyzed using a known analysis method such as IR, NMR, various types of mass spectrometry, X-ray analysis, Raman spectroscopy, GPC, DSC, or DMA.

### Hydrogen Sulfide Adsorbent

When the packaging materials 10, 20, 100, 200, and 300 of the present embodiment are used for an all-solid-state battery, depending on the type of solid electrolyte, hydrogen sulfide may be generated by a reaction of the solid electrolyte with water. Thus, a material (hydrogen sulfide adsorbent) that decomposes or adsorbs hydrogen sulfide may be added to the packaging materials 10, 20, 100, 200, and 300. The hydrogen sulfide adsorbent can be added, for example, to at least one of the first adhesive layer 12a, the second adhesive layer 12b, and the sealant layer 16. When the outer side of the packaging materials 10, 20, 100, 200, and 300 is the substrate layer 11 side of the packaging materials 10, 20, 100, 200, and 300 and the inner side of the packaging materials 10, 20, 100, 200, and 300 is the sealant layer 16 side of the packaging materials 10, 20, 100, 200, and 300, the hydrogen sulfide adsorbent is preferably added to at least one of the layers located closer to the inner side than the barrier layer 13 because in such a case, the hydrogen sulfide adsorbent is more likely to adsorb hydrogen sulfide generated inside the packaging materials 10, 20, 100, 200, and 300, and in particular, the hydrogen sulfide adsorbent is preferably added to the sealant layer 16 because in such a case, the hydrogen sulfide adsorbent is more effective.

Examples of the hydrogen sulfide adsorbent include zinc oxide, amorphous metal silicate salts (mainly amorphous metal silicate salts in which the metal is copper or zinc), hydrate of zirconium and a lanthanoid element, tetravalent metal phosphates (particularly tetravalent metal phosphates in which the metal is copper), a mixture of zeolite and zinc ions, a mixture of zeolite, zinc oxide, and copper oxide (II), potassium permanganate, sodium permanganate, silver sulfate, silver acetate, aluminum oxide, iron hydroxide, isocyanate compounds, aluminum silicate, aluminum potassium sulfate, zeolite, activated carbon, amine compounds, and ionomers. Of these, zinc oxide is preferable from the viewpoint of easier detoxification of hydrogen sulfide, cost, and handleability. Hydrogen sulfide adsorbents can be used singly or in combination of two or more.

The hydrogen sulfide adsorbent may be added to a single layer or a plurality of layers. In the case where the hydrogen sulfide adsorbent is added to the sealant layer 16, a highly concentrated material prepared in advance as a masterbatch may be added to the resin of the sealant layer 16 so that the hydrogen sulfide adsorbent is at an appropriate concentration. In the case where the hydrogen sulfide adsorbent is added to the first adhesive layer 12a or the second adhesive layer 12b, when the adhesive layer is formed by applying an adhesive, the hydrogen sulfide adsorbent may be directly added to a coating liquid, and when the adhesive layer is formed by extrusion or the like, a masterbatch may be prepared and added in the same manner as in the sealant layer 16. The resin used to prepare a masterbatch may be a thermoplastic resin such as polyolefin, polyamide, polyester, polycarbonate, polyphenylene ether, polyacetal, polystyrene, polyvinyl chloride, or polyvinyl acetate.

When the hydrogen sulfide adsorbent is added to the packaging material, in order to impart dispersibility, scalability, heat resistance, and other function, for example, a dispersant, an antioxidant, a slip agent, a flame retardant, an anti-blocking agent, a photostabilizer, a dehydrating agent, a tackifier, a crystal nucleating agent, a plasticizer, and the like may be added to the packaging material.

The hydrogen sulfide adsorbent content is preferably 0.01 to 30 mass %, and more preferably 0.1 to 20 mass %, with respect to the total solid content of the layer to which the hydrogen sulfide adsorbent is added. This is because if the hydrogen sulfide adsorbent content is less than 0.01 mass %, the effect of hydrogen sulfide detoxification is low, and if the hydrogen sulfide adsorbent content exceeds 30 mass %, the physical properties of the layer to which the hydrogen sulfide adsorbent is added tend to be deteriorated.

### Method of Producing Packaging Material

### First Aspect

First, an example of a method of producing the packaging material 10 shown in FIG. 1 will be described. The method of producing the packaging material 10 is not limited to the following method.

The method of producing the packaging material 10 of the present embodiment includes a step of forming the anticorrosion treatment layers 14a and 14b on the barrier layer 13, a step of forming the primer layer 17 on the surface of the barrier layer 13 on the anticorrosion treatment layer 14a side, a step of bonding the substrate layer 11 to the barrier layer 13 using the first adhesive layer 12a, a step of further laminating the sealant layer 16 via the second adhesive layer 12b to prepare a laminate, and if necessary, a step of aging the obtained laminate.

### Step of Laminating Anticorrosion Treatment Layers 14a and 14b on Barrier Layer 13

In this step, the anticorrosion treatment layers 14a and 14b are formed on the barrier layer 13. As described above, the anticorrosion treatment layers 14a and 14b may be formed on the barrier layer 13 by applying degreasing treatment, hydrothermal conversion treatment, anodic oxidation treatment, or chemical conversion treatment to the barrier layer 13, or applying a coating agent having anticorrosion properties to the barrier layer 13.

The anticorrosion treatment layers 14a and 14b as a multilayer may be formed, for example, by applying, to the barrier layer 13, a coating liquid (coating agent) for forming an anticorrosion treatment layer on the lower side (the barrier layer 13 side), and baking the coating agent to form a first layer, and then applying, to the first layer, a coating liquid (coating agent) for forming an anticorrosion treatment layer on the upper side, and baking the coating agent to form a second layer.

The degreasing treatment may be performed by spraying or immersion. The hydrothermal conversion treatment and the anodic oxidation treatment may be performed by immersion. The chemical conversion treatment may be performed by a method appropriately selected from immersion, spraying, coating, and the like, according to the type of chemical conversion treatment.

The coating agent having anticorrosion properties may be applied using various coating methods such as gravure coating, reverse coating, roll coating, or bar coating.

As described above, various treatments may be applied to one or both surfaces of the metal foil. When treatment is applied to one surface of the metal foil, the treatment is preferably applied to the surface of the metal foil on the side on which the sealant layer 16 is to be laminated. If necessary, the treatment may also be applied to the surface of the substrate layer 11.

The amounts of coating agents for forming the first and second layers are preferably both 0.005 to 0.200 g/m², and more preferably 0.010 to 0.100 g/m².

If necessary, dry curing may be performed in a base material temperature range of 60 to 300° C. according to the drying conditions for the anticorrosion treatment layers 14a and 14b used.

### Step of Forming Primer Layer 17 on Anticorrosion Treatment Layer 14a

In this step, the primer layer 17 is formed on the surface of the barrier layer 13 on the anticorrosion treatment layer 14a side. The primer layer 17 can be formed by applying a primer layer forming composition onto the anticorrosion treatment layer 14a, followed by curing. The curing is preferably performed before the barrier layer 13 and the substrate layer 11 are bonded to each other via a coating film composed of the primer layer forming composition. The coating method and curing conditions are as described above. In this step, the barrier layer 13 with the primer layer 17 is obtained.

### Step of Bonding Substrate Layer 11 to Barrier Layer 13

In this step, the substrate layer 11 is bonded via the first adhesive layer 12a to the barrier layer 13 with the primer layer 17 obtained by forming the primer layer 17 on the barrier layer 13 provided with the anticorrosion treatment layers 14a and 14b. The substrate layer 11 is bonded to the surface of the barrier layer 13 with the primer layer 17 on the primer layer 17 side. The bonding is performed using a method such as dry lamination, non-solvent lamination, or wet lamination to bond the layers with the material for forming the first adhesive layer 12a described above. The first adhesive layer 12a is preferably provided so that the dry coating amount of the first adhesive layer 12a is in the range of 1 to 10 g/m², and more preferably in the range of 2 to 7 g/m².

### Step of Laminating Second Adhesive Layer 12b and Sealant Layer 16

In this step, the sealant layer 16 is bonded via the second adhesive layer 12b to the surface of the barrier layer 13 on the second anticorrosion treatment layer 14b side. The bonding may be performed by a method such as a wet process or dry lamination.

In the wet process, a solution or a dispersion of the adhesive for forming the second adhesive layer 12b is applied onto the second anticorrosion treatment layer 14b, and the solvent is evaporated at a predetermined temperature and dried to form a film, followed by baking if necessary. Then, the sealant layer 16 is laminated to produce the packaging material 10. The adhesive may be applied by any of the various coating methods described above. The preferred dry coating amount of the second adhesive layer 12b is the same as that of the first adhesive layer 12a.

In this case, for example, a sealant layer forming resin composition containing the components of the sealant layer 16 described above may be used to form the sealant layer 16 using a melt extrusion molding machine. The processing speed of the melt extrusion molding machine may be 80 m/min or more, from the viewpoint of productivity.

### Aging Step

In this step, the laminate is aged (cured). Aging of the laminate can promote adhesion between the substrate layer 11, the first adhesive layer 12a, the primer layer 17, the first anticorrosion treatment layer 14a, and the barrier layer 13, and adhesion between the barrier layer 13, the second anticorrosion treatment layer 14b, the second adhesive layer 12b, and the sealant layer 16. The laminate may be aged in the range of room temperature to 100° C. The aging time is, for example, 1 to 10 days.

In this manner, the packaging material 10 of the present embodiment as shown in FIG. 1 can be produced.

Next, an example of a method of producing the packaging material 20 shown in FIG. 2 will be described. The method of producing the packaging material 20 is not limited to the following method.

The method of producing the packaging material 20 of the present embodiment includes a step of forming the anticorrosion treatment layers 14a and 14b on the barrier layer 13, a step of forming the primer layer 17 on the surface of the barrier layer 13 on the anticorrosion treatment layer 14a side, a step of bonding the substrate layer 11 to the barrier layer 13 using the first adhesive layer 12a, a step of further laminating the adhesive resin layer 15 and the sealant layer 16 to prepare a laminate, and if necessary, a step of heat treating the obtained laminate. The steps up to the step of bonding the substrate layer 11 to the barrier layer 13 can be performed in the same manner as in the method of producing the packaging material 10 described above.

### Step of Laminating Adhesive Resin Layer 15 and Sealant Layer 16

In this step, the adhesive resin layer 15 and the sealant layer 16 are formed on the second anticorrosion treatment layer 14b formed in the earlier step. The adhesive resin layer 15 and the sealant layer 16 may be formed by sandwich lamination of the adhesive resin layer 15 together with the sealant layer 16 using an extrusion laminator. Alternatively, the adhesive resin layer 15 and the sealant layer 16 may be laminated by tandem lamination or coextrusion in which the adhesive resin layer 15 and the sealant layer 16 are extruded. When the adhesive resin layer 15 and the sealant layer 16 are formed, for example, the components are mixed so that the adhesive resin layer 15 and the sealant layer 16 are configured as described above. The sealant layer forming resin composition described above is used to form the sealant layer 16.

In this step, a laminate is obtained in which the substrate layer 11, the first adhesive layer 12a, the primer layer 17, the first anticorrosion treatment layer 14a, the barrier layer 13, the second anticorrosion treatment layer 14b, the adhesive resin layer 15, and the sealant layer 16 are laminated in this order as shown in FIG. 2.

The adhesive resin layer 15 may be laminated by preparing materials dry blended according to the material formulation described above, and directly extruding the materials using an extrusion laminator. Alternatively, the adhesive resin layer 15 may be laminated by preparing granules obtained in advance by melt blending using a melt-kneading device such as a single-screw extruder, a twin-screw extruder, or a Brabender mixer, and extruding the granules using an extrusion laminator.

The sealant layer 16 may be laminated by preparing materials dry blended according to the material formulation described above as the components of the sealant layer forming resin composition, and directly extruding the materials using an extrusion laminator. Alternatively, the adhesive resin layer 15 and the sealant layer 16 may be laminated by preparing granules obtained in advance by melt blending using a melt-kneading device such as a single-screw extruder, a twin-screw extruder, or a Brabender mixer, and extruding the granules as the adhesive resin layer 15 and the sealant layer 16 using an extrusion laminator by tandem lamination or coextrusion. Alternatively, the adhesive resin layer 15 and the sealant layer 16 may be laminated by forming a sealant single film as a cast film in advance using a sealant layer forming resin composition, and performing sandwich lamination of the film together with an adhesive resin. The adhesive resin layer 15 and the sealant layer 16 may be formed, for example, at a speed (processing speed) of 80 m/min or more, from the viewpoint of productivity.

### Heat Treatment Step

In this step, the laminate is heat treated. Heat treatment of the laminate can improve the adhesion between the barrier layer 13, the second anticorrosion treatment layer 14b, the adhesive resin layer 15, and the sealant layer 16. In the heat treatment, the laminate is preferably heat treated at least at a temperature of not less than the melting point of the adhesive resin layer 15.

In this manner, the packaging material 20 of the present embodiment as shown in FIG. 2 can be produced.

### Second Aspect

Next, an example of a method of producing the packaging material 100 shown in FIG. 3 will be described. The method of producing the packaging material 100 is not limited to the following method.

The method of producing the packaging material 100 of the present embodiment includes a step of forming the anticorrosion treatment layers 14a and 14b on the barrier layer 13, a step of bonding the substrate layer 11 to the barrier layer 13 using the first adhesive layer 12a, a step of forming the primer layer 17 on the surface of the barrier layer 13 on the anticorrosion treatment layer 14b side, a step of further laminating the sealant layer 16 via the second adhesive layer 12b to prepare a laminate, and if necessary, a step of aging the obtained laminate.

### Step of Laminating Anticorrosion Treatment Layers 14a and 14b on Barrier Layer 13

In this step, the anticorrosion treatment layers 14a and 14b are formed on the barrier layer 13. As described above, the anticorrosion treatment layers 14a and 14b may be formed on the barrier layer 13 by applying degreasing treatment, hydrothermal conversion treatment, anodic oxidation treatment, or chemical conversion treatment to the barrier layer 13, or applying a coating agent having anticorrosion properties to the barrier layer 13.

The anticorrosion treatment layers 14a and 14b as a multilayer may be formed, for example, by applying, to the barrier layer 13, a coating liquid (coating agent) for forming an anticorrosion treatment layer on the lower side (the barrier layer 13 side), and baking the coating agent to form a first layer, and then applying, to the first layer, a coating liquid (coating agent) for forming an anticorrosion treatment layer on the upper side, and baking the coating agent to form a second layer.

The degreasing treatment may be performed by spraying or immersion. The hydrothermal conversion treatment and the anodic oxidation treatment may be performed by immersion. The chemical conversion treatment may be performed by a method appropriately selected from immersion, spraying, coating, and the like, according to the type of chemical conversion treatment.

The coating agent having anticorrosion properties may be applied using various coating methods such as gravure coating, reverse coating, roll coating, or bar coating.

As described above, various treatments may be applied to one or both surfaces of the metal foil. When treatment is applied to one surface of the metal foil, the treatment is preferably applied to the surface of the metal foil on the side on which the sealant layer 16 is to be laminated. If necessary, the treatment may also be applied to the surface of the substrate layer 11.

The amounts of coating agents for forming the first and second layers are preferably both 0.005 to 0.200 g/m², and more preferably 0.010 to 0.100 g/m².

If necessary, dry curing may be performed in a base material temperature range of 60 to 300° C. according to the drying conditions for the anticorrosion treatment layers 14a and 14b used.

### Step of Bonding Substrate Layer 11 to Barrier Layer 13

In this step, the substrate layer 11 is bonded via the first adhesive layer 12a to the barrier layer 13 provided with the anticorrosion treatment layers 14a and 14b. The substrate layer 11 is bonded to the surface of the barrier layer 13 on the anticorrosion treatment layer 14a side. The bonding is performed using a method such as dry lamination, non-solvent lamination, or wet lamination to bond the layers with the material for forming the first adhesive layer 12a described above. The first adhesive layer 12a is preferably provided so that the dry coating amount of the first adhesive layer 12a is in the range of 1 to 10 g/m², and more preferably in the range of 2 to 7 g/m².

### Step of Forming Primer Layer 17 on Anticorrosion Treatment Layer 14b

In this step, the primer layer 17 is formed on the surface of the barrier layer 13 on the anticorrosion treatment layer 14b side. The primer layer 17 can be formed by applying a primer layer forming composition onto the anticorrosion treatment layer 14b, followed by curing. The curing is preferably performed before the barrier layer 13 and the sealant layer 16 are bonded to each other via a coating film composed of the primer layer forming composition. The coating method and curing conditions are as described above. In this step, a laminate with the primer layer 17 is obtained.

### Step of Laminating Second Adhesive Layer 12b and Sealant Layer 16

In this step, the sealant layer 16 is bonded via the second adhesive layer 12b to the surface of the laminate with the primer layer 17 on the primer layer 17 side. The bonding may be performed by a method such as a wet process or dry lamination.

In the wet process, a solution or a dispersion of the adhesive for forming the second adhesive layer 12b is applied onto the primer layer 17, and the solvent is evaporated at a predetermined temperature and dried to form a film, followed by baking if necessary. Then, the sealant layer 16 is laminated to produce the packaging material 100. The adhesive may be applied by any of the various coating methods described above. The preferred dry coating amount of the second adhesive layer 12b is the same as that of the first adhesive layer 12a.

In this case, for example, a sealant layer forming resin composition containing the components of the sealant layer 16 described above may be used to form the sealant layer 16 using a melt extrusion molding machine. The processing speed of the melt extrusion molding machine may be 80 m/min or more, from the viewpoint of productivity.

### Aging Step

In this step, the laminate is aged (cured). Aging of the laminate can promote adhesion between the substrate layer 11, the first adhesive layer 12a, the first anticorrosion treatment layer 14a, and the barrier layer 13, and adhesion between the barrier layer 13, the second anticorrosion treatment layer 14b, the primer layer 17, the second adhesive layer 12b, and the sealant layer 16. The laminate may be aged in the range of room temperature to 100° C. The aging time is, for example, 1 to 10 days.

In this manner, the packaging material 100 of the present embodiment as shown in FIG. 3 can be produced.

Next, an example of a method of producing the packaging material 200 shown in FIG. 4 will be described. The method of producing the packaging material 200 is not limited to the following method.

The method of producing the packaging material 200 of the present embodiment includes a step of forming the anticorrosion treatment layers 14a and 14b on the barrier layer 13, a step of bonding the substrate layer 11 to the barrier layer 13 using the first adhesive layer 12a, a step of forming the primer layer 17 on the surface of the barrier layer 13 on the anticorrosion treatment layer 14b side, a step of further laminating the adhesive resin layer 15 and the sealant layer 16 to prepare a laminate, and if necessary, a step of heat treating the obtained laminate. The steps up to the step of obtaining a laminate with the primer layer 17 can be performed in the same manner as in the method of producing the packaging material 100 described above.

### Step of Laminating Adhesive Resin Layer 15 and Sealant Layer 16

In this step, the adhesive resin layer 15 and the sealant layer 16 are formed on the primer layer 17 of the laminate with the primer layer 17 formed in the earlier step. The adhesive resin layer 15 and the sealant layer 16 may be formed by sandwich lamination of the adhesive resin layer 15 together with the sealant layer 16 using an extrusion laminator. Alternatively, the adhesive resin layer 15 and the sealant layer 16 may be laminated by tandem lamination or coextrusion in which the adhesive resin layer 15 and the sealant layer 16 are extruded. When the adhesive resin layer 15 and the sealant layer 16 are formed, for example, the components are mixed so that the adhesive resin layer 15 and the sealant layer 16 are configured as described above. The sealant layer forming resin composition described above is used to form the sealant layer 16.

In this step, a laminate is obtained in which the substrate layer 11, the first adhesive layer 12a, the first anticorrosion treatment layer 14a, the barrier layer 13, the second anticorrosion treatment layer 14b, the primer layer 17, the adhesive resin layer 15, and the sealant layer 16 are laminated in this order as shown in FIG. 4.

The adhesive resin layer 15 may be laminated by preparing materials dry blended according to the material formulation described above, and directly extruding the materials using an extrusion laminator. Alternatively, the adhesive resin layer 15 may be laminated by preparing granules obtained in advance by melt blending using a melt-kneading device such as a single-screw extruder, a twin-screw extruder, or a Brabender mixer, and extruding the granules using an extrusion laminator.

The sealant layer 16 may be laminated by preparing materials dry blended according to the material formulation described above as the components of the sealant layer forming resin composition, and directly extruding the materials using an extrusion laminator. Alternatively, the adhesive resin layer 15 and the sealant layer 16 may be laminated by preparing granules obtained in advance by melt blending using a melt-kneading device such as a single-screw extruder, a twin-screw extruder, or a Brabender mixer, and extruding the granules as the adhesive resin layer 15 and the sealant layer 16 using an extrusion laminator by tandem lamination or coextrusion. Alternatively, the adhesive resin layer 15 and the sealant layer 16 may be laminated by forming a sealant single film as a cast film in advance using a sealant layer forming resin composition, and performing sandwich lamination of the film together with an adhesive resin. The adhesive resin layer 15 and the sealant layer 16 may be formed, for example, at a speed (processing speed) of 80 m/min or more, from the viewpoint of productivity.

### Heat Treatment Step

In this step, the laminate is heat treated. Heat treatment of the laminate can improve the adhesion between the barrier layer 13, the second anticorrosion treatment layer 14b, the primer layer 17, the adhesive resin layer 15, and the sealant layer 16. In the heat treatment, the laminate is preferably heat treated at least at a temperature of not less than the melting point of the adhesive resin layer 15.

In this manner, the packaging material 200 of the present embodiment as shown in FIG. 4 can be produced.

The packaging material 300 shown in FIG. 5 can be produced by combining the method of producing the packaging material 100 and the method of producing the packaging material 200 described above.

Preferred embodiments of the power storage device packaging material of the present disclosure have been described in detail. However, the present disclosure is not limited to such specific embodiments, and may be variously modified and changed within the spirit of the present disclosure recited in the claims.

The power storage device packaging material of the present disclosure can be preferably used as a packaging material for power storage devices including, for example, secondary batteries such as lithium-ion batteries, nickel hydride batteries, and lead batteries, and electrochemical capacitors such as electric double layer capacitors. In particular, the power storage device packaging material of the present disclosure can maintain good heat sealability even when used under high temperature environmental conditions after heat sealing, and thus is preferable as a packaging material for an all-solid-state battery including a solid electrolyte expected to be used in such an environment.

### Power Storage Device

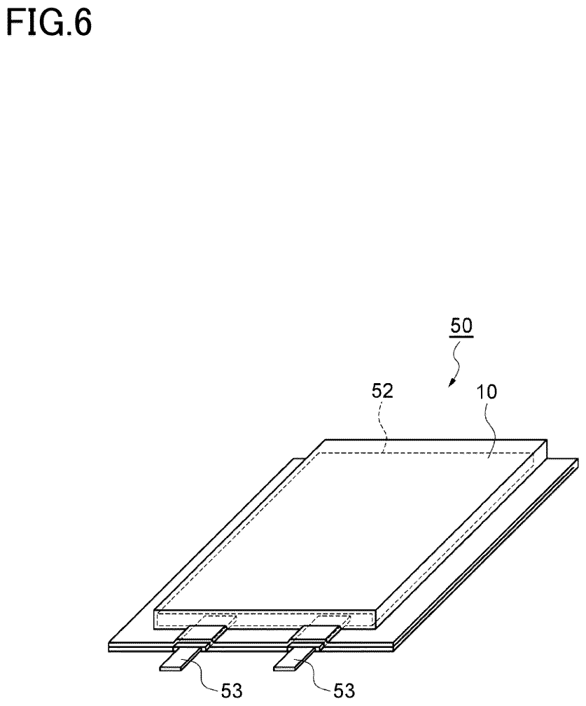

FIG. 6 is a perspective view showing an embodiment of a power storage device produced using the packaging material described above. As shown in FIG. 6, a power storage device 50 includes a battery element (power storage device body) 52 including electrodes, two metal terminals (leads, current output terminals) 53 that extend from the electrodes and are used to externally output an electric current from the battery element 52, and the packaging material 10 in which the battery element 52 is sealed. The packaging material 10 of the power storage device 50 is the packaging material 10 according to the present embodiment described above and is used as a container for housing the battery element 52. In the packaging material 10, the substrate layer 11 is the outermost layer, and the sealant layer 16 is the innermost layer. Thus, the packaging material 10 in which the battery element 52 is housed is formed by folding a single laminate film into two or stacking two laminate films so that the substrate layer 11 faces the outside of the power storage device 50 and the sealant layer 16 faces the inside of the power storage device 50, followed by heat sealing of the edge portions of the laminate film or the two laminate films. The metal terminals 53 are sandwiched and sealed by the packaging material 10 that serves as a container in which the sealant layer 16 is located on the inner side. The metal terminals 53 may be sandwiched by the packaging material 10 via a tab sealant. The power storage device 50 may include the packaging material 20, the packaging material 100, the packaging material 200, or the packaging material 300, instead of the packaging material 10.

In the battery element 52, an electrolyte is interposed between a positive electrode and a negative electrode. The metal terminals 53 are a part of a current collector extended to the outside of the packaging material 10, and are composed of a metal foil such as a copper foil or an aluminum foil.

The power storage device 50 of the present embodiment may be an all-solid-state battery. In such a case, the battery element 52 includes, as an electrolyte, a solid electrolyte such as a sulfide solid electrolyte. The power storage device 50 of the present embodiment includes the packaging material 10 of the present embodiment, and thus good lamination strength can be ensured even when the power storage device 50 is used under high temperature environmental conditions (e.g., 150° C.) In the case where the power storage device 50 of the present embodiment includes the packaging material 100, 200, or 300 of the present embodiment, good heat sealing strength can be ensured even when the power storage device 50 is used under high temperature environmental conditions (e.g., 150° C.)

### EXAMPLES

In the following, the present disclosure will be more specifically described by way of examples. However, the present disclosure is not limited to the following examples. The terms “part(s)” and “%” are on a mass basis unless otherwise specified.

### First Aspect

### Materials Used

Materials used in the examples and comparative examples are as follows.

### Substrate Layer (thickness: 25 μm)

Ny: A nylon (Ny) film (manufactured by Toyobo Co., Ltd.) having a corona-treated surface was used.
PET: A polyethylene terephthalate film having a corona-treated surface was used.

### First Adhesive Layer (Mass Per Unit Area: 4.0 g/m²)

A first adhesive was used. The first adhesive was obtained by mixing each of the base resins and the corresponding curing agent shown in Table 1 at the corresponding NCO/OH ratio shown in Table 1, followed by dilution with ethyl acetate to a solid content of 26 mass %. Details of components constituting the first adhesive are as follows.

### Base Resin

A-1: Polyether polyol (manufactured by Adeka Corporation, trade name: G-400, hydroxyl value: 390 mgKOH/g)
A-2: Acrylic polyol (manufactured by Taisei Fine Chemical Co., Ltd., trade name: 6KW-700, hydroxyl value: 10 mgKOH/g)
A-3: Polycarbonate diol (manufactured by Asahi Kasei Corporation, trade name: T5652, hydroxyl value: 113 mgKOH/g)
A-4: Polyester polyol (manufactured by Showa Denko Materials Co., Ltd., trade name: TL 2505-63, hydroxyl value: 7 to 11 mgKOH/g)

### Curing Agent

B-1: Adduct of hexamethylene diisocyanate (manufactured by Asahi Kasei Corporation, trade name: DURANATE P301-75E)
B-2: Adduct of tolylene diisocyanate (manufactured by Mitsui Chemicals, Inc., trade name: TAKENATE 500)
B-3: Isocyanurate of isophorone diisocyanate (manufactured by Mitsui Chemicals, Inc., trade name: TAKENATE 600)

### First Anticorrosion Treatment Layer (Substrate Layer Side) and Second Anticorrosion Treatment Layer (Sealant Layer Side)

(CL-1): A sodium polyphosphate-stabilized cerium oxide sol was used in which the solid content concentration was adjusted to 10 mass % using distilled water as a solvent. The sodium polyphosphate-stabilized cerium oxide sol was obtained by mixing 10 parts by mass of Na salt of phosphoric acid with respect to 100 parts by mass of cerium oxide.
(CL-2): A composition composed of 90 mass % of polyallylamine (manufactured by Nitto Boseki Co., Ltd.) and 10 mass % of polyglycerol polyglycidyl ether (manufactured by Nagase Chemtex Corporation) was used in which the solid content concentration was adjusted to 5 mass % using distilled water as a solvent.

### Barrier Layer (Thickness: 40 μm)

SUS: Stainless steel (manufactured by Nippon Steel & Sumikin Materials Co., Ltd., trade name: SUS304-BA) was used.
AL: An annealed and degreased soft aluminum foil (8079 manufactured by Toyo Aluminium K.K.) was used.

### Second Adhesive Layer (Mass Per Unit Area: 3 g/m²)

A polyurethane adhesive obtained by adding polyisocyanate to acid-modified polyolefin dissolved in a mixed solvent of toluene and methylcyclohexane was used.

### Primer Layer (Thickness: Approximately 2.0 nm)

A primer layer forming composition obtained by diluting each of the following silane coupling agents with ethanol to a concentration of 0.4 mass % was used.
SC-1: Ureidopropyltrialkoxysilane (Dow Toray Co., Ltd., trade name: DOWSIL (registered trademark) Z-6119 Silane)
SC-2: 3-Isocyanatopropyltriethoxysilane (manufactured by Azuchi Sangyo Co., Ltd., trade name: NQ-885)
SC-3: 3-Isocyanatopropylmethyldiethoxysilane (manufactured by Azuchi Sangyo Co., Ltd., trade name: NQ-881)
SC-4: 3-Isocyanatopropyltriethoxysilane (manufactured by Tokyo Chemical Industry Co., Ltd., trade name: I0556)
SC-5: 3-(2-Aminoethylamino)propyldimethoxymethylsilane (manufactured by Tokyo Chemical Industry Co., Ltd., trade name: A0876)
SC-6: 3-Aminopropyldimethoxymethylsilane (manufactured by Tokyo Chemical Industry Co., Ltd., trade name: A2628)
SC-7: Polymer-type polyfunctional aminosilane coupling agent (manufactured by Shin-Etsu Chemical Co., Ltd., trade name: X-12-972F)
SC-8: P-styryltrimethylsilane (manufactured by Shin-Etsu Chemical Co., Ltd., trade name: KBM-1403)

### Sealant Layer (Thickness: 80 μm)

A polyolefin film (unstretched polypropylene film having a corona-treated surface on the second adhesive layer side) was used.

### Preparation of Packaging Material

### Example 1-1

A primer layer forming composition containing the silane coupling agent shown in Table 1 was applied onto one surface of the barrier layer by small-diameter gravure coating, followed by drying and curing at 60° C. for 1 minute, thereby forming a primer layer having a thickness of 2.0 nm. Thus, the barrier layer with the primer layer was formed.

The surface of the barrier layer with the primer layer on the primer layer side and the corona-treated surface of the substrate layer were bonded to each other by dry lamination using a first adhesive (first adhesive layer) containing the base resin and the curing agent shown in Table 1. In lamination of the barrier layer with the primer layer and the substrate layer, the first adhesive was applied onto the primer layer so that the coating amount (mass per unit area) of the first adhesive after drying was 4.0 g/m², and dried at 80° C. for 1 minute, followed by lamination with the substrate layer and aging at 80° ° C. for 120 hours.

Then, the surface of the barrier layer facing away from the substrate layer was bonded to the sealant layer (thickness: 80 μm) by dry lamination using a polyurethane adhesive (second adhesive layer). In lamination of the barrier layer and the sealant layer, the polyurethane adhesive was applied onto the surface of the barrier layer facing away from the substrate layer so that the coating amount (mass per unit area) of the polyurethane adhesive after drying was 3 g/m², and dried at 80° C. for 1 minute, followed by lamination with the sealant layer and aging at 120° C. for 3 hours. In this manner, a packaging material (a laminate of the substrate layer, the first adhesive layer, the primer layer, the barrier layer, the second adhesive layer, and the sealant layer) was prepared.

### Examples 1-2 to 1-5

A packaging material (a laminate of the substrate layer, the first adhesive layer, the primer layer, the barrier layer, the second adhesive layer, and the sealant layer) of each of Examples 1-2 to 1-5 was prepared in the same manner as in Example 1-1 except that the type of silane coupling agent contained in the primer layer forming composition and/or the type of barrier layer was changed as shown in Table 1.

### Example 1-6

First, first and second anticorrosion treatment layers were formed on the barrier layer by the following procedure. Specifically, the material (CL-1) was applied to both surfaces of the barrier layer by micro gravure coating so that the dry coating amount of the material (CL-1) was 70 mg/m², followed by baking at 200° C. in a drying unit. Then, onto the obtained layer, the material (CL-2) was applied by micro gravure coating so that the dry coating amount of the material (CL-2) was 20 mg/m², thereby forming a composite layer composed of the materials (CL-1) and (CL-2) as the first and second anticorrosion treatment layers. The two materials (CL-1) and (CL-2) were combined to form the composite layer having corrosion resistance.

A packaging material (a laminate of the substrate layer, the first adhesive layer, the primer layer, the first anticorrosion treatment layer, the barrier layer, the second anticorrosion treatment layer, the second adhesive layer, and the sealant layer) of Example 1-6 was prepared in the same manner as in Example 1-5 except that a barrier layer provided with the first and second anticorrosion treatment layers was used.

### Examples 1-7 to 1-17

A packaging material (a laminate of the substrate layer, the first adhesive layer, the primer layer, the first anticorrosion treatment layer, the barrier layer, the second anticorrosion treatment layer, the second adhesive layer, and the sealant layer) of each of Examples 1-7 to 1-17 was prepared in the same manner as in Example 1-6 except that the composition of the first adhesive and/or the type of substrate layer was changed as shown in Table 1.

### Examples 1-18 and 1-19

A packaging material (a laminate of the substrate layer, the first adhesive layer, the primer layer, the first anticorrosion treatment layer, the barrier layer, the second anticorrosion treatment layer, the second adhesive layer, and the sealant layer) of each of Examples 1-18 and 1-19 was prepared in the same manner as in Example 1-14 except that the type of silane coupling agent contained in the primer layer forming composition was changed as shown in Table 1.

### Comparative Example 1-1

A packaging material (a laminate of the substrate layer, the first adhesive layer, the barrier layer, the second adhesive layer, and the sealant layer) of Comparative Example 1-1 was prepared in the same manner as in Example 1-1 except that no primer layer was provided.

### Comparative Example 1-2

A packaging material (a laminate of the substrate layer, the first adhesive layer, the primer layer, the first anticorrosion treatment layer, the barrier layer, the second anticorrosion treatment layer, the second adhesive layer, and the sealant layer) of Comparative Example 1-2 was prepared in the same manner as in Example 1-6 except that the type of silane coupling agent contained in the primer layer forming composition was changed as shown in Table 1.

### XPS Measurement

In the prepared packaging materials, the substrate layer was physically peeled off from the barrier layer. On the surface of the barrier layer after peeling, the primer layer and at least part of the first adhesive layer remained. The remaining first adhesive layer was removed by etching using an argon gas cluster ion beam (Ar-GCIB). The surface of the primer layer after removal of the first adhesive layer was analyzed by X-ray photoelectron spectroscopy (XPS). By XPS measurement, a peak area S (Si) of a peak P (Si) that was derived from Si 2p3/2 and detected in the range of 99 to 104 eV and a peak area S (N) of a peak P(N) that was derived from N1s and detected in the range of 396 to 404 eV were calculated, and an area ratio S (Si)/S (N) was obtained. Furthermore, the presence or absence of a peak P (Al) derived from Al 2p3/2 was determined in the same manner. The measurement device and measurement conditions for the X-ray photoelectron spectroscopy are as follows.
Measurement device: JPS-9030 (trade name) manufactured by JEOL Ltd.
Incident X-rays: Mg Kα (non-monochromatic x-ray, hv=1253.6 eV)
X-ray output: 10 kV· 10 mA (100 W)
Photoelectron capture angle: 90°
Measurement region: 6 mmφ
Peak shift correction: Correction was performed so that the maximum binding energy of the C1s peak was 285 eV.

The XPS measurement results are shown in Table 1. In the packaging material of Comparative Example 1-1, no primer layer was provided, and thus no XPS measurement was performed. In the packaging material of Comparative Example 1-2, no peak P(N) was detected.

### Measurement of Lamination Strength

### Lamination Strength Under Room Temperature Environmental Conditions

From each of the packaging materials, a piece having a width of 15 mm was cut out, and in the piece of the packaging materials, the lamination strength between the barrier layer and the substrate layer under room temperature (25° C.) environmental conditions was measured by a 90-degree peel test at a tensile speed of 50 mm/min using a tensile tester (manufactured by Shimadzu Corporation). Based on the obtained lamination strength, the packaging materials were evaluated according to the following criteria. The results are shown in Table 2.
A: Lamination strength was 6.0 N/15 mm or more.
B: Lamination strength was 4.5 N/15 mm or more and less than 6.0 N/15 mm.
C: Lamination strength was 3.0 N/15 mm or more and less than 4.5 N/15 mm.
D: Lamination strength was less than 3.0 N/15 mm.

### Lamination Strength Under High Temperature Environmental Conditions

From each of the packaging materials, a piece having a width of 15 mm was cut out and left to stand under high temperature environmental conditions of 150° C. for 5 minutes. Then, in the piece of the packaging materials, the lamination strength between the barrier layer and the substrate layer in a 150° C. environment was measured by a 90-degree peel test at a tensile speed of 50 mm/min using a tensile tester (manufactured by Shimadzu Corporation). Based on the obtained lamination strength, the packaging materials were evaluated according to the following criteria. The results are shown in Table 2.
A: Lamination strength was 3.0 N/15 mm or more.
B: Lamination strength was 2.0 N/15 mm or more and less than 3.0 N/15 mm.
C: Lamination strength was 1.0 N/15 mm or more and less than 2.0 N/15 mm.
D: Lamination strength was less than 1.0 N/15 mm.

### Evaluation of Environmental Reliability

Each of the packaging materials was deep drawn to a forming depth of 3.00 mm using a forming apparatus. The samples (five samples) after deep drawing were stored in a 150° C. environment for 1 week. Then, the samples were visually observed while a portion of the samples in the vicinity of the formation protrusion was irradiated with light, to determine whether delamination between the substrate layer and the barrier layer occurred. The packaging materials were evaluated for environmental reliability according to the following criteria. The results are shown in Table 2.
A: No delamination was observed in any of the five samples.
B: Delamination was observed in one or two of the five samples.
D: Delamination was observed in three or more of the five samples.

### Evaluation of Anticorrosion Properties

From each of the packaging materials, a piece having a width of 15 mm was cut out and allowed to stand at a hydrogen sulfide concentration of 20 ppm in a 100° C. environment for 1 week. Then, in the piece of the packaging materials, the lamination strength between the barrier layer and the substrate layer under room temperature (25° C.) environmental conditions was measured by a 90-degree peel test at a tensile speed of 50 mm/min using a tensile tester (manufactured by Shimadzu Corporation). The strength retention of the lamination strength after exposure to hydrogen sulfide relative to the lamination strength before exposure to hydrogen sulfide measured as the “Lamination strength under room temperature environmental conditions” was calculated. The packaging materials were evaluated for anticorrosion properties according to the following criteria. The results are shown in Table 2.
A: Strength retention was 95% or more.
B: Strength retention was 90% or more and less than 95%.
C: Strength retention was less than 90%.

### Evaluation of Yellowing

A sample (single sample) after deep drawing was prepared in the same manner as the samples for the “Evaluation of environmental reliability”, and the sample was stored in a 170° C. environment for 1 week. Then, the sample was visually observed to determine whether yellowing of the substrate surface occurred. The packaging materials were evaluated for yellowing according to the following criteria. The results are shown in Table 2.
A: No yellowing was observed.
B: Yellowing was observed.

TABLE 1

| | Primer layer | | | | Presence | | | | |
|---|---|---|---|---|---|---|---|---|---|
| | | Area | | | of anti- | First adhesive layer | | | |
| | Silane | ratio | Presence | | corrosion | | | NCO/ | |
| | coupling | S(Si)/ | of P | Barrier | treatment | Base | Curing | OH | Substrate |
| | agent | S(N) | (Al) | layer | layers | resin | agent | ratio | layer |
| Example 1-1 | SC-1 | 0.3 | Not | SUS | Not present | A-1 | B-1 | 1.5 | Ny |
| | | | present | | | | | | |
| Example 1-2 | SC-2 | 0.6 | Not | SUS | Not present | A-1 | B-1 | 1.5 | Ny |
| | | | present | | | | | | |
| Example 1-3 | SC-3 | 2.0 | Not | SUS | Not present | A-1 | B-1 | 1.5 | Ny |
| | | | present | | | | | | |
| Example 1-4 | SC-4 | 0.8 | Present | AL | Not present | A-1 | B-1 | 1.5 | Ny |
| Example 1-5 | SC-5 | 0.6 | Present | AL | Not present | A-1 | B-1 | 1.5 | Ny |
| Example 1-6 | SC-5 | 0.6 | Present | AL | Present | A-1 | B-1 | 1.5 | Ny |
| Example 1-7 | SC-5 | 0.6 | Present | AL | Present | A-1 | B-2 | 1.5 | Ny |
| Example 1-8 | SC-5 | 0.6 | Present | AL | Present | A-1 | B-3 | 1.5 | Ny |
| Example 1-9 | SC-5 | 0.6 | Present | AL | Present | A-2 | B-3 | 1.5 | Ny |
| Example 1-10 | SC-5 | 0.6 | Present | AL | Present | A-3 | B-3 | 1.5 | Ny |
| Example 1-11 | SC-5 | 0.6 | Present | AL | Present | A-4 | B-3 | 1.5 | Ny |
| Example 1-12 | SC-5 | 0.6 | Present | AL | Present | A-4 | B-3 | 3.0 | Ny |
| Example 1-13 | SC-5 | 0.6 | Present | AL | Present | A-4 | B-3 | 10.0 | Ny |
| Example 1-14 | SC-5 | 0.6 | Present | AL | Present | A-4 | B-3 | 20.0 | Ny |
| Example 1-15 | SC-5 | 0.6 | Present | AL | Present | A-4 | B-3 | 30.0 | Ny |
| Example 1-16 | SC-5 | 0.6 | Present | AL | Present | A-4 | B-3 | 40.0 | Ny |
| Example 1-17 | SC-5 | 0.6 | Present | AL | Present | A-4 | B-3 | 20.0 | PET |
| Example 1-18 | SC-6 | 1.0 | Present | AL | Present | A-4 | B-3 | 20.0 | Ny |
| Example 1-19 | SC-7 | 0.3 | Present | AL | Present | A-4 | B-3 | 20.0 | Ny |
| Comparative | — | — | Not | SUS | Not present | A-1 | B-1 | 1.5 | Ny |
| Example 1-1 | | | present | | | | | | |
| Comparative | SC-8 | — | Present | AL | Present | A-1 | B-1 | 1.5 | Ny |
| Example 1-2 | | | | | | | | | |

TABLE 2

| | Lamination strength | | | | | | Anticorrosion | | |
|---|---|---|---|---|---|---|---|---|---|
| | Room temperature | | 150° C. | | Environmental reliability | | properties | | |
| | environment | | environment | | 150° C.-1 w | | Strength | | |
| | N/15 | | N/15 | | Number of | | retention | | |
| | mm | Evaluation | mm | Evaluation | Delaminations | Evaluation | (%) | Evaluation | Yellowing |
| Ex. 1-1 | 4.90 | B | 1.10 | C | 0 | A | 92 | B | A |
| Ex. 1-2 | 5.20 | B | 1.50 | C | 0 | A | 92 | B | A |
| Ex. 1-3 | 5.10 | B | 1.30 | C | 0 | A | 92 | B | A |
| Ex. 1-4 | 5.60 | B | 1.90 | C | 0 | A | 91 | B | A |
| Ex. 1-5 | 5.60 | B | 2.00 | B | 0 | A | 91 | B | A |
| Ex. 1-6 | 5.60 | B | 2.00 | B | 0 | A | 100 | A | A |
| Ex. 1-7 | 6.10 | A | 2.30 | B | 0 | A | 100 | A | B |
| Ex. 1-8 | 6.60 | A | 2.50 | B | 0 | A | 100 | A | A |
| Ex. 1-9 | 6.20 | A | 2.60 | B | 0 | A | 100 | A | A |
| Ex. 1-10 | 6.00 | A | 2.70 | B | 0 | A | 100 | A | A |
| Ex. 1-11 | 7.00 | A | 2.90 | B | 0 | A | 100 | A | A |
| Ex. 1-12 | 6.90 | A | 3.00 | A | 0 | A | 100 | A | A |
| Ex. 1-13 | 6.70 | A | 3.20 | A | 0 | A | 100 | A | A |
| Ex. 1-14 | 6.50 | A | 3.80 | A | 0 | A | 100 | A | A |
| Ex. 1-15 | 6.50 | A | 3.50 | A | 0 | A | 100 | A | A |
| Ex. 1-16 | 6.20 | A | 3.10 | A | 0 | A | 100 | A | A |
| Ex. 1-17 | 6.50 | A | 4.10 | A | 0 | A | 100 | A | A |
| Ex. 1-18 | 6.10 | A | 3.40 | A | 0 | A | 100 | A | A |
| Ex. 1-19 | 6.80 | A | 4.50 | A | 0 | A | 100 | A | A |
| Comp. | 4.60 | B | 0.10 | D | 5 | D | 100 | A | A |
| Ex. | | | | | | | | | |
| 1-1 | | | | | | | | | |
| Comp. | 4.80 | B | 0.60 | D | 5 | D | 100 | A | A |
| Ex. | | | | | | | | | |
| 1-2 | | | | | | | | | |

### Second Aspect

### Materials Used

Materials used in the examples and comparative examples are as follows.

### Substrate Layer (Thickness: 25 μm)

PET: A polyethylene terephthalate film having a corona-treated surface was used.

### First Adhesive Layer (Mass Per Unit Area: 4.0 g/m²)

A first adhesive was used. The first adhesive was obtained by mixing a polyester polyol (manufactured by Showa Denko Materials Co., Ltd., trade name: TL 2505-63, hydroxyl value: 7 to 11 mgKOH/g) and an isocyanurate of isophorone diisocyanate (manufactured by Mitsui Chemicals, Inc., trade name: TAKENATE 600) at an NCO/OH ratio of 20.0, followed by dilution with ethyl acetate to a solid content of 26 mass %.

### First Anticorrosion Treatment Layer (Substrate Layer Side) and Second Anticorrosion Treatment Layer (Sealant Layer Side)

(CL-1): A sodium polyphosphate-stabilized cerium oxide sol was used in which the solid content concentration was adjusted to 10 mass % using distilled water as a solvent. The sodium polyphosphate-stabilized cerium oxide sol was obtained by mixing 10 parts by mass of Na salt of phosphoric acid with respect to 100 parts by mass of cerium oxide.
(CL-2): A composition composed of 90 mass % of polyallylamine (manufactured by Nitto Boseki Co., Ltd.) and 10 mass % of polyglycerol polyglycidyl ether (manufactured by Nagase Chemtex Corporation) was used in which the solid content concentration was adjusted to 5 mass % using distilled water as a solvent.

### Barrier Layer (Thickness: 40 μm)

AL: An annealed and degreased soft aluminum foil (8079 manufactured by Toyo Aluminium K.K.) was used.

### Primer Layer, Second Adhesive Layer, Adhesive Resin Layer, and Sealant Layer

The materials used to form the primer layer, the second adhesive layer, the adhesive resin layer, and the sealant layer are shown in Table 3 below. A primer layer forming composition obtained by diluting each of the silane coupling agents shown in Table 3 with ethanol to a concentration of 0.4 mass % was used to form the primer layer. Details of the silane coupling agents are as follows.
A1: Ureidopropyltrialkoxysilane (Dow Toray Co., Ltd., trade name: DOWSIL (registered trademark) Z-6119 Silane)
A2: 3-Isocyanatopropyltriethoxysilane (manufactured by Azuchi Sangyo Co., Ltd., trade name: NQ-885)
A3: 3-Isocyanatopropyltriethoxysilane (manufactured by Tokyo Chemical Industry Co., Ltd., trade name: I0556)
A4: 3-Isocyanatopropylmethyldiethoxysilane (manufactured by Azuchi Sangyo Co., Ltd., trade name: NQ-881)
A5: Polymer-type polyfunctional aminosilane coupling agent (manufactured by Shin-Etsu Chemical Co., Ltd., trade name: X-12-972F)
A6: 3-(2-Aminoethylamino)propyldimethoxymethylsilane (manufactured by Tokyo Chemical Industry Co., Ltd., trade name: A0876)
A7: 3-Aminopropyldimethoxymethylsilane (manufactured by Tokyo Chemical Industry Co., Ltd., trade name: A2628)
A8: 3-Methacryloxypropylmethyldimethoxysilane (manufactured by Shin-Etsu Chemical Co., Ltd., trade name: KBM-502)

TABLE 3

| | | | | | Melting |
|---|---|---|---|---|---|
| Layer | No. | Materials | | | point |
| Primer | A1 | Silane | Ureido- | Ureidopropyltrialkoxysilane | — |
| layer | | coupling | based | | |
| | A2 | agent | Isocyanate- | 3-Isocyanatepropyltriethoxysilane | — |
| | A3 | | based | 3-Isocyanatepropyltriethoxysilane | — |
| | A4 | | | 3-Isocyanatepropylmethyldiethoxysilane | — |
| | A5 | | Amino- | Polymer-type polyfunctional aminosilane | — |
| | | | based | coupling agent | |
| | A6 | | | 3-(2- | — |
| | | | | Aminoethylamino)propyldimethoxymethylsilane | |
| | A7 | | | 3-Aminopropyldimethoxymethylsilane | — |
| | A8 | | Methacryl- | 3-Methacryloxypropylmethyldimethoxysilane | — |
| | | | based | | |
| | A9 | | Amino + | Blended at A6:A8 = 4:6 | — |
| | | | Methacryl- | | |
| | | | based | | |
| Second | B1 | PP adhesive | | Acid-modified polyolefin + Polyfunctional | — |
| adhesive | | | | isocyanate compound | |
| layer | B2 | Urethane adhesive | | Same as material of first adhesive layer | — |
| Adhesive | C1 | Acid-modified PP | | Maleic anhydride-modified homopolypropylene | 164° C. |
| resin | C2 | | | Maleic anhydride-modified block polypropylene | 163° C. |
| layer | C3 | | | Imine-modified homopolypropylene | 164° C. |
| Sealant | D1 | PP | | Block polypropylene | 164° C. |
| layer | D2 | | | Homopolypropylene | 163° C. |

| | | | | |
|---|---|---|---|---|
| | D3 | Polyester | Copolymer of terephthalic acid and ethylene | 207° C. |
| | | | glycol/neopentyl glycol | |
| Common to | E1 | Long-chain branched PP | Homopolypropylene having branched chains | 157° C. |
| adhesive | | | with 500 or more carbon atoms | |
| resin | | | | |
| layer and | | | | |
| Sealant | | | | |
| layer | | | | |

### Preparation of Packaging Material

### Example 2-1

First, first and second anticorrosion treatment layers were formed on the barrier layer by the following procedure. Specifically, the material (CL-1) was applied to both surfaces of the barrier layer by micro gravure coating so that the dry coating amount of the material (CL-1) was 70 mg/m², followed by baking at 200° C. in a drying unit. Then, onto the obtained layer, the material (CL-2) was applied by micro gravure coating so that the dry coating amount of the material (CL-2) was 20 mg/m², thereby forming a composite layer composed of the materials (CL-1) and (CL-2) as the first and second anticorrosion treatment layers. The two materials (CL-1) and (CL-2) were combined to form the composite layer having corrosion resistance.

Next, the surface of the barrier layer with the anticorrosion treatment layers on the first anticorrosion treatment layer side and the corona-treated surface of the substrate layer were bonded to each other by dry lamination using a first adhesive (first adhesive layer). In lamination of the barrier layer with the anticorrosion treatment layers and the substrate layer, the first adhesive was applied onto the first anticorrosion treatment layer so that the coating amount (mass per unit area) of the first adhesive after drying was 4.0 g/m2, and dried at 80° C. for 1 minute, followed by lamination with the substrate layer and aging at 8020 C. for 120 hours.

A primer layer forming composition containing the silane coupling agent shown in Table 4 was applied by small-diameter gravure coating onto the second anticorrosion treatment layer of the obtained laminate of the barrier layer and the substrate, followed by drying and curing at 60° C. for 1 minute, thereby forming a primer layer having a thickness of 2.0 nm. Thus, a laminate with the primer layer was formed.

Then, the laminate with the primer layer was placed in an unwinding unit of an extrusion laminator, and an adhesive resin layer (thickness: 26.7 μm) and a sealant layer (thickness: 53.3 μm) were coextruded onto the primer layer under processing conditions of 270° C. and 80 m/min so that the adhesive resin layer and the sealant layer were laminated in this order. The adhesive resin layer and the sealant layer used in the extrusion lamination were obtained by preparing in advance compounds of various materials shown in Tables 3 and 4 using a twin-screw extruder, followed by water cooling and pelletizing. Long-chain branched PP was added to the compounds at the ratio (the content with respect to the total solid content of the compounds) shown in Table 4.

The laminate obtained in this manner was heat treated so that the maximum temperature reached by the laminate was 190° C., thereby preparing a packaging material (a laminate of the substrate layer, the first adhesive layer, the first anticorrosion treatment layer, the barrier layer, the second anticorrosion treatment layer, the primer layer, the adhesive resin layer, and the sealant layer).

### Examples 2-2 to 2-7

A packaging material (a laminate of the substrate layer, the first adhesive layer, the first anticorrosion treatment layer, the barrier layer, the second anticorrosion treatment layer, the primer layer, the adhesive resin layer, and the sealant layer) of each of Examples 2-2 to 2-7 was prepared in the same manner as in Example 2-1 except that the type of silane coupling agent contained in the primer layer forming composition was changed as shown in Table 4.

### Example 2-8

A packaging material (a laminate of the substrate layer, the first adhesive layer, the first anticorrosion treatment layer, the barrier layer, the second anticorrosion treatment layer, the primer layer, the adhesive resin layer, and the sealant layer) was prepared in the same manner as in Example 2-6 except that the thickness of the primer layer was set to 15 nm.

### Example 2-9

A packaging material (a laminate of the substrate layer, the first adhesive layer, the barrier layer, the primer layer, the adhesive resin layer, and the sealant layer) was prepared in the same manner as in Example 2-6 except that no first or second anticorrosion treatment layer was provided.

### Examples 2-10 to 2-18, 2-23, and 2-24

A packaging material (a laminate of the substrate layer, the first adhesive layer, the first anticorrosion treatment layer, the barrier layer, the second anticorrosion treatment layer, the primer layer, the adhesive resin layer, and the sealant layer) of each of Examples 2-10 to 2-18, 2-23, and 2-24 was prepared in the same manner as in Example 2-6 except that the composition of the adhesive resin layer and/or the sealant layer was changed as shown in Table 4.

### Examples 2-19 to 2-22

A packaging material (a laminate of the substrate layer, the first adhesive layer, the first anticorrosion treatment layer, the barrier layer, the second anticorrosion treatment layer, the primer layer, the adhesive resin layer, and the sealant layer) of each of Examples 2-19 to 2-22 was prepared in the same manner as in Example 2-6 except that the thicknesses of the adhesive resin layer and the sealant layer were changed as shown in Table 4.

### Example 2-25

A laminate with the primer layer was prepared in the same manner as in Example 2-6. Next, the sealant layer (thickness: 80 μm) shown in Tables 3 and 4 was bonded onto the primer layer of the laminate with the primer layer by dry lamination using the second adhesive layer shown in Tables 3 and 4. In lamination of the laminate with the primer layer and the sealant layer, an adhesive for forming the second adhesive layer was applied onto the primer layer so that the thickness of the adhesive after drying was 3 μm, and dried at 80° C. for 1 minute, followed by lamination with the sealant layer and aging at 120° C. for 3 hours. In this manner, a packaging material (a laminate of the substrate layer, the first adhesive layer, the first anticorrosion treatment layer, the barrier layer, the second anticorrosion treatment layer, the primer layer, the second adhesive layer, and the sealant layer) was prepared.

### Examples 2-26 and 2-27

A packaging material (a laminate of the substrate layer, the first adhesive layer, the first anticorrosion treatment layer, the barrier layer, the second anticorrosion treatment layer, the primer layer, the second adhesive layer, and the sealant layer) of each of Examples 2-26 and 2-27 was prepared in the same manner as in Example 2-25 except that the composition of the second adhesive layer and/or the sealant layer was changed as shown in Table 4.

### Example 2-28

A laminate with the primer layer was prepared in the same manner as in Example 2-6. Furthermore, a second barrier layer having the same configuration as the barrier layer of the laminate with the primer layer was prepared. The second barrier layer was bonded onto the primer layer of the laminate with the primer layer by dry lamination using the second adhesive layer shown in Tables 3 and 4 so that the first anticorrosion treatment layer faced the primer layer. In lamination of the laminate with the primer layer and the second barrier layer, an adhesive for forming the second adhesive layer was applied onto the primer layer so that the thickness of the adhesive after drying was 3 μm, and dried at 80° C. for 1 minute, followed by lamination with the second barrier layer and aging at 120° C. for 3 hours. Thus, a laminate with the second barrier layer was obtained.

Next, a primer layer forming composition containing the silane coupling agent shown in Table 4 was applied by small-diameter gravure coating onto the second anticorrosion treatment layer of the second barrier layer of the laminate with the second barrier layer, followed by drying and curing at 60° C. for 1 minute, thereby forming a second primer layer having a thickness of 2.0 nm. Thus, a laminate with the second primer layer was formed.

Then, the laminate with the second primer layer was placed in an unwinding unit of an extrusion laminator, and an adhesive resin layer (thickness: 26.7 μm) and a sealant layer (thickness: 53.3 μm) were coextruded onto the second primer layer under processing conditions of 270° C. and 80 m/min so that the adhesive resin layer and the sealant layer were laminated in this order. The adhesive resin layer and the sealant layer used in the extrusion lamination were obtained by preparing in advance compounds of various materials shown in Tables 3 and 4 using a twin-screw extruder, followed by water cooling and pelletizing. Long-chain branched PP was added to the compounds at the ratio (the content with respect to the total solid content of the compounds) shown in Table 4.

The laminate obtained in this manner was heat treated so that the maximum temperature reached by the laminate was 190° C., thereby preparing a packaging material (a laminate of the substrate layer, the first adhesive layer, the first anticorrosion treatment layer, the barrier layer (first barrier layer), the second anticorrosion treatment layer, the primer layer (first primer layer), the second adhesive layer, the first anticorrosion treatment layer, the second barrier layer, the second anticorrosion treatment layer, the second primer layer, the adhesive resin layer, and the sealant layer).

### Comparative Examples 2-1 and 2-2

A packaging material (a laminate of the substrate layer, the first adhesive layer, the first anticorrosion treatment layer, the barrier layer, the second anticorrosion treatment layer, the primer layer, the adhesive resin layer, and the sealant layer) of each of Comparative Examples 2-1 and 2-2 was prepared in the same manner as in Example 2-1 except that the type of silane coupling agent contained in the primer layer forming composition was changed as shown in Table 4.

### Comparative Example 2-3

A packaging material (a laminate of the substrate layer, the first adhesive layer, the first anticorrosion treatment layer, the barrier layer, the second anticorrosion treatment layer, the adhesive resin layer, and the sealant layer) was prepared in the same manner as in Example 2-1 except that no primer layer was provided.

### XPS Measurement

In the prepared packaging materials, the sealant layer and the adhesive resin layer (the sealant layer only in the packaging material including no adhesive resin layer) were physically peeled off from the barrier layer. On the surface of the barrier layer after peeling, the primer layer (except for Comparative Example 2-3) and at least part of the adhesive resin layer or the second adhesive layer remained. The remaining adhesive resin layer or second adhesive layer was removed by etching using an argon gas cluster ion beam (Ar-GCIB). Then, the surface of the primer layer was analyzed by X-ray photoelectron spectroscopy (XPS). By XPS measurement, a peak area S (Si) of a peak P (Si) that was derived from Si 2p3/2 and detected in the range of 99 to 104 eV and a peak area S (N) of a peak P(N) that was derived from N1s and detected in the range of 396 to 404 eV were calculated, and an area ratio S (Si)/S (N) was obtained. Furthermore, the presence or absence of a peak P (Al) derived from Al 2p3/2 was determined in the same manner. The measurement device and measurement conditions for the X-ray photoelectron spectroscopy are as follows.
Measurement device: JPS-9030 (trade name) manufactured by JEOL Ltd. Incident X-rays: Mg Kα (non-monochromatic x-ray, hv=1253.6 eV)
X-ray output: 10 kV· 10 mA (100 W)
Photoelectron capture angle: 90°
Measurement region: 6 mmφ
Peak shift correction: Correction was performed so that the maximum binding energy of the C1s peak was 285 eV.

The XPS measurement results are shown in Table 4. In the packaging material of Comparative Example 2-1, no peak P(N) was detected. In the packaging material of Comparative Example 2-3, no primer layer was provided, and thus no XPS measurement was performed.

### Measurement of Heat Sealing Strength at Room Temperature

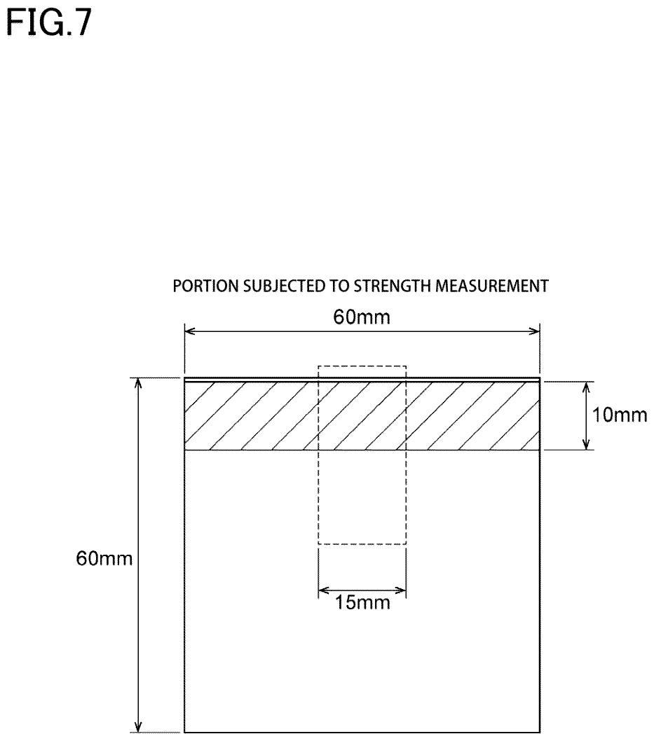

From each of the packaging materials, a sample having a size of 60 mm×120 mm was cut out and folded into two, and one side of the sample was heat-sealed at 220° C. and 0.5 MPa for 10 seconds using a seal bar having a width of 10 mm. Subsequently, the heat-sealed portion was cut into a piece having a width of 15 mm (see FIG. 7), and the sealing strength (T-peel strength) of the piece was measured using a tester (manufactured by INSTRON). The test was performed in accordance with JIS K6854 at 23° C. in a 50% RH atmosphere at a peeling rate of 50 mm/min.

Based on the measured values of the sealing strength (burst strength), the packaging materials were evaluated according to the following criteria. The results are shown in Table 5. The evaluation result C or better indicates a pass.
A: Sealing strength was 90 N/15 mm or more.
B: Sealing strength was 80 N /15 mm or more and less than 90 N/15 mm.
C: Sealing strength was 70 N/15 mm or more and less than 80 N/15 mm.
D: Sealing strength was less than 70 N/15 mm.

### Measurement of Heat Sealing Strength at High Temperature

From each of the packaging materials, a sample having a size of 60 mm×120 mm was cut out and folded into two, and one side of the sample was heat-sealed at 220° C. and 0.5 MPa for 10 seconds using a seal bar having a width of 10 mm. Subsequently, the heat-sealed portion was cut into a piece having a width of 15 mm (see FIG. 7) and allowed to stand in a 150° C. environment for 5 minutes, and then the sealing strength (T-peel strength) of the piece at a peeling rate of 50 mm/min in a 150° C. environment was measured using a tester (manufactured by INSTRON). Based on the measured values of the sealing strength (burst strength), the packaging materials were evaluated according to the following criteria. The results are shown in Table 5. The evaluation result C or better indicates a pass.
A: Sealing strength was 35 N/15 mm or more.
B: Sealing strength was 30 N /15 mm or more and less than 35 N/15 mm.
C: Sealing strength was 20 N/15 mm or more and less than 30 N/15 mm.
D: Sealing strength was less than 20 N/15 mm.

### Evaluation of Anticorrosion Properties

The packaging materials were allowed to stand at a hydrogen sulfide concentration of 20 ppm in a 100° ° C. environment for 1 week. Then, in the packaging materials, the sealing strength was measured by the same procedure as in the [Measurement of heat sealing strength at high temperature]. The strength retention of the heat sealing strength after exposure to hydrogen sulfide relative to the heat sealing strength before exposure to hydrogen sulfide measured as the “Measurement of heat sealing strength at high temperature” was calculated. The packaging materials were evaluated for anticorrosion properties according to the following criteria. The results are shown in Table 5.
A: Strength retention was 95% or more.
B: Strength retention was 90% or more and less than 95%.
C: Strength retention was 85% or more and less than 90%.
D: Strength retention was less than 85%.

TABLE 4

| | | | | | | | | | | | | | Adhesive | |
|---|---|---|---|---|---|---|---|---|---|---|---|---|---|---|
| | | | | | | | | | | | | | resin layer + | |
| | | | | | | | Adhesive resin layer | | | Sealant layer | | | Sealant layer | |
| | Presence | | | | | | | | Long- | | | Long- | Thickness | |
| | of | Primer layer | | | | Sec- | | | chain | | | chain | ratio of | Long- |
| | anti- | | Area | | Pres- | ond | | | branched | | | branched | adhesive | chain |
| | corrosion | | ratio | Func- | ence | adhe- | Thick- | Base | PP | Thick- | Base | PP | resin | branched |
| | treatment | Mater- | S(Si)/ | tional | of P | sive | ness | mater- | (E1) | ness | mater- | (E1) | layer/seal- | PP (E1) |
| | layers | ial | S(N) | group | (Al) | layer | [μm] | ial | amount | [μm] | ial | amount | ant layer | amount |
| Ex. | Present | A1 | 0.3 | Ureido | Present | — | 26.7 | C1 | 5% | 53.3 | D1 | 5% | 0.5 | 5% |
| 2-1 | | | | | | | | | | | | | | |
| Ex. | Present | A2 | 0.6 | Iso- | Present | — | 26.7 | C1 | 5% | 53.3 | D1 | 5% | 0.5 | 5% |
| 2-2 | | | | cyanate | | | | | | | | | | |
| Ex. | Present | A3 | 0.8 | Iso- | Present | — | 26.7 | C1 | 5% | 53.3 | D1 | 5% | 0.5 | 5% |
| 2-3 | | | | cyanate | | | | | | | | | | |
| Ex. | Present | A4 | 2.0 | Iso- | Present | — | 26.7 | C1 | 5% | 53.3 | D1 | 5% | 0.5 | 5% |
| 2-4 | | | | cyanate | | | | | | | | | | |
| Ex. | Present | A5 | 0.3 | Amino | Present | — | 26.7 | C1 | 5% | 53.3 | D1 | 5% | 0.5 | 5% |
| 2-5 | | | | | | | | | | | | | | |
| Ex. | Present | A6 | 0.6 | Amino | Present | — | 26.7 | C1 | 5% | 53.3 | D1 | 5% | 0.5 | 5% |
| 2-6 | | | | | | | | | | | | | | |
| Ex. | Present | A7 | 1.0 | Amino | Present | — | 26.7 | C1 | 5% | 53.3 | D1 | 5% | 0.5 | 5% |
| 2-7 | | | | | | | | | | | | | | |
| Ex. | Present | A6 | 0.6 | Amino | Not | — | 26.7 | C1 | 5% | 53.3 | D1 | 5% | 0.5 | 5% |
| 2-8 | | | | | present | | | | | | | | | |
| Ex. | Not | A6 | 0.6 | Amino | Present | — | 26.7 | C1 | 5% | 53.3 | D1 | 5% | 0.5 | 5% |
| 2-9 | present | | | | | | | | | | | | | |
| Ex | Present | A6 | 0.6 | Amino | Present | — | 26.7 | C3 | 5% | 53.3 | D1 | 5% | 0.5 | 5% |
| 2-10 | | | | | | | | | | | | | | |
| Ex | Present | A6 | 0.6 | Amino | Present | — | 26.7 | C1 | 0% | 53.3 | D1 | 0% | 0.5 | 0% |
| 2-11 | | | | | | | | | | | | | | |
| Ex | Present | A6 | 0.6 | Amino | Present | — | 26.7 | C1 | 15% | 53.3 | D1 | 0% | 0.5 | 5% |
| 2-12 | | | | | | | | | | | | | | |
| Ex. | Present | A6 | 0.6 | Amino | Present | — | 26.7 | C1 | 0% | 53.3 | D1 | 8% | 0.5 | 5% |
| 2-13 | | | | | | | | | | | | | | |
| Ex. | Present | A6 | 0.6 | Amino | Present | — | 26.7 | C1 | 1% | 53.3 | D1 | 1% | 0.5 | 1% |
| 2-14 | | | | | | | | | | | | | | |
| Ex | Present | A6 | 0.6 | Amino | Present | — | 26.7 | C1 | 0.5% | 53.3 | D1 | 0.5% | 0.5 | 1% |
| 2-15 | | | | | | | | | | | | | | |
| Ex | Present | A6 | 0.6 | Amino | Present | — | 26.7 | C1 | 15% | 53.3 | D1 | 15% | 0.5 | 15% |
| 2-16 | | | | | | | | | | | | | | |
| Ex. | Present | A6 | 0.6 | Amino | Present | — | 26.7 | C1 | 30% | 53.3 | D1 | 30% | 0.5 | 30% |
| 2-17 | | | | | | | | | | | | | | |
| Ex | Present | A6 | 0.6 | Amino | Present | — | 26.7 | C1 | 35% | 53.3 | D1 | 35% | 0.5 | 35% |
| 2-18 | | | | | | | | | | | | | | |
| Ex | Present | A6 | 0.6 | Amino | Present | — | 3.0 | C1 | 5% | 77.0 | D1 | 5% | 0.04 | 5% |
| 2-19 | | | | | | | | | | | | | | |
| Ex. | Present | A6 | 0.6 | Amino | Present | — | 5.0 | C1 | 5% | 75.0 | D1 | 5% | 0.1 | 5% |
| 2-20 | | | | | | | | | | | | | | |
| Ex. | Present | A6 | 0.6 | Amino | Present | — | 40.0 | C1 | 5% | 40.0 | D1 | 5% | 1.0 | 5% |
| 2-21 | | | | | | | | | | | | | | |
| Ex. | Present | A6 | 0.6 | Amino | Present | — | 60.0 | C1 | 5% | 20.0 | D1 | 5% | 3.0 | 5% |
| 2-22 | | | | | | | | | | | | | | |
| Ex. | Present | A6 | 0.6 | Amino | Present | — | 26.7 | C2 | 5% | 53.3 | D1 | 5% | 0.5 | 5% |
| 2-23 | | | | | | | | | | | | | | |
| Ex | Present | A6 | 0.6 | Amino | Present | — | 26.7 | C1 | 5% | 53.3 | D2 | 5% | 0.5 | 5% |
| 2-24 | | | | | | | | | | | | | | |
| Ex | Present | A6 | 0.6 | Amino | Present | B1 | — | — | — | 80.0 | D1 | 5% | — | 5% |
| 2-25 | | | | | | | | | | | | | | |
| Ex | Present | A6 | 0.6 | Amino | Present | B2 | — | — | — | 80.0 | D1 | 5% | — | 5% |
| 2-26 | | | | | | | | | | | | | | |
| Ex | Present | A6 | 0.6 | Amino | Present | B2 | — | — | — | 80.0 | D3 | — | — | — |
| 2-27 | | | | | | | | | | | | | | |
| Ex | Present | A6 | 0.6 | Amino | Present | B2 | 26.7 | C1 | 5% | 53.3 | D1 | 5% | 0.5 | 5% |
| 2-28 | | | | | | | | | | | | | | |
| Comp. | Present | A8 | — | Meth- | Present | — | 26.7 | C1 | 5% | 53.3 | D1 | 5% | 0.5 | 5% |
| Ex. | | | | acryl | | | | | | | | | | |
| 2-1 | | | | | | | | | | | | | | |
| Comp. | Present | A9 | 2.2 | Amino, | Present | — | 26.7 | C1 | 5% | 53.3 | D1 | 5% | 0.5 | 5% |
| Ex. | | | | Meth- | | | | | | | | | | |
| 2-2 | | | | acryl | | | | | | | | | | |
| Comp. | Present | — | — | — | Present | — | 26.7 | C1 | 5% | 53.3 | D1 | 5% | 0.5 | 5% |
| Ex. | | | | | | | | | | | | | | |
| 2-3 | | | | | | | | | | | | | | |

TABLE 5

| | Heat sealing strength | | | | Anticorrosion | |
|---|---|---|---|---|---|---|
| | Room temperature | | 150° C. | | properties | |
| | environment | | environment | | Strength | |
| | N/15 | | N/15 | | retention | |
| | mm | Evaluation | mm | Evaluation | [%] | Evaluation |
| Ex. 2-1 | 105 | A | 42 | A | 100 | A |
| Ex. 2-2 | 100 | A | 40 | A | 100 | A |
| Ex. 2-3 | 93 | A | 32 | B | 100 | A |
| Ex. 2-4 | 81 | B | 22 | C | 100 | A |
| Ex. 2-5 | 117 | A | 49 | A | 100 | A |
| Ex. 2-6 | 115 | A | 48 | A | 100 | A |
| Ex. 2-7 | 100 | A | 34 | B | 100 | A |
| Ex. 2-8 | 98 | A | 32 | B | 100 | A |
| Ex. 2-9 | 113 | A | 46 | A | 91 | B |
| Ex. 2-10 | 92 | A | 31 | B | 100 | A |
| Ex. 2-11 | 113 | A | 30 | B | 100 | A |
| Ex. 2-12 | 113 | A | 37 | A | 100 | A |
| Ex. 2-13 | 113 | A | 33 | B | 100 | A |
| Ex. 2-14 | 115 | A | 37 | A | 100 | A |
| Ex. 2-15 | 115 | A | 34 | B | 100 | A |
| Ex. 2-16 | 110 | A | 40 | A | 100 | A |
| Ex. 2-17 | 105 | A | 38 | A | 100 | A |
| Ex. 2-18 | 99 | A | 31 | B | 100 | A |
| Ex. 2-19 | 101 | A | 34 | B | 100 | A |
| Ex. 2-20 | 107 | A | 45 | A | 100 | A |
| Ex. 2-21 | 109 | A | 36 | A | 100 | A |
| Ex. 2-22 | 87 | B | 29 | C | 100 | A |
| Ex. 2-23 | 113 | A | 47 | A | 100 | A |
| Ex. 2-24 | 114 | A | 48 | A | 100 | A |
| Ex. 2-25 | 110 | A | 34 | B | 100 | A |
| Ex. 2-26 | 111 | A | 45 | A | 100 | A |
| Ex. 2-27 | 95 | A | 45 | A | 100 | A |
| Ex. 2-28 | 122 | A | 51 | A | 100 | A |
| Comp. Ex. | 72 | C | 12 | D | 100 | A |
| 2-1 | | | | | | |
| Comp. Ex. | 77 | C | 18 | D | 100 | A |
| 2-2 | | | | | | |
| Comp. Ex. | 71 | C | 12 | D | 100 | A |
| 2-3 | | | | | | |

### INDUSTRIAL APPLICABILITY

The first aspect of the present disclosure provides a power storage device packaging material capable of ensuring good lamination strength under both room temperature environmental conditions and high temperature environmental conditions, and a power storage device including the power storage device packaging material.

The second aspect of the present disclosure provides a power storage device packaging material capable of ensuring good heat sealing strength under both room temperature environmental conditions and high temperature environmental conditions, and a power storage device including the power storage device packaging material.
[Reference Signs List] 10, 20, 100, 200, 300 . . . Power storage device packaging material; 11 . . . Substrate layer; 12a . . . First adhesive layer; 12b . . . Second adhesive layer; 13 . . . Barrier layer; 14a . . . First anticorrosion treatment layer; 14b . . . Second anticorrosion treatment layer; 15 . . . Adhesive resin layer; 16 . . . Sealant layer; 17 . . . Primer layer; 50 . . . Power storage device; 52 . . . Battery element; 53 . . . Metal terminal.

What is claimed is:

1. A power storage device packaging material, comprising:
at least a substrate layer, a first adhesive layer, a primer layer, a barrier layer, a second adhesive layer or an adhesive resin layer, and a sealant layer in this order, wherein
by X-ray photoelectron spectroscopy analysis of a surface of the primer layer facing the first adhesive layer, a peak P(Si) derived from Si 2p3/2 is detected in a range of 99 eV to 104 eV, and a peak P(N) derived from N1s is detected in a range of 396 eV to 404 eV, and
an area ratio S(Si)/S(N) between a peak area S(Si) of the peak P(Si) and a peak area S(N) of the peak P(N) is 2.0 or less.

2. The power storage device packaging material of claim 1, wherein
the barrier layer is a metal foil made of aluminum or an aluminum alloy, and
by X-ray photoelectron spectroscopy analysis of the surface of the primer layer facing the first adhesive layer, a peak P (Al) derived from Al 2p3/2 is detected in a range of 70 eV to 78 eV.

3. The power storage device packaging material of claim 1, wherein
the primer layer is a layer that is composed of a primer layer forming composition containing a silane coupling agent and that is formed through a dehydration condensation reaction of the silane coupling agent.

4. The power storage device packaging material of claim 3, wherein the silane coupling agent is a compound having an amino group or an isocyanate group.

5. The power storage device packaging material of claim 1, comprising an anticorrosion treatment layer at one or both of a position between the barrier layer and the primer layer and a position between the second adhesive layer and the barrier layer.

6. The power storage device packaging material of claim 1, wherein
the first adhesive layer is a layer that is composed of an adhesive composition containing a polyfunctional isocyanate compound, and
the polyfunctional isocyanate compound is at least one polyfunctional isocyanate compound selected from a group consisting of an alicyclic isocyanate multimer and an isocyanate multimer having a molecular structure containing an aromatic ring.

7. The power storage device packaging material of claim 6, wherein the adhesive composition is a urethane adhesive composition containing at least one polyol selected from a group consisting of a polyester polyol, an acrylic polyol, and a polycarbonate diol, and the polyfunctional isocyanate compound.

8. The power storage device packaging material of claim 7, wherein a ratio (NCO/OH) of a number of isocyanate groups contained in the polyfunctional isocyanate compound to a number of hydroxyl groups contained in the polyol is 1.5 to 40.0.

9. The power storage device packaging material of claim 1, wherein the substrate layer is a polyamide film or a polyester film.

10. A power storage device packaging material, comprising:
at least a substrate layer, a first adhesive layer, a barrier layer, a second adhesive layer or an adhesive resin layer, and a sealant layer in this order, wherein
the power storage device packaging material comprises a primer layer at a position between layers from the barrier layer to the sealant layer,
by X-ray photoelectron spectroscopy analysis of a surface of the primer layer facing the sealant layer, a peak P (Si) derived from Si 2p3/2 is detected in a range of 99 eV to 104 eV, and a peak P(N) derived from N1s is detected in a range of 396 eV to 404 eV, and
an area ratio S (Si)/S (N) between a peak area S (Si) of the peak P (Si) and a peak area S (N) of the peak P(N) is 2.0 or less.

11. The power storage device packaging material of claim 10, wherein
the barrier layer is a metal foil made of aluminum or an aluminum alloy, and
by X-ray photoelectron spectroscopy analysis of the surface of the primer layer facing the sealant layer, a peak P (Al) derived from Al 2p3/2 is detected in a range of 70 eV to 78 eV.

12. The power storage device packaging material of claim 10, wherein
the primer layer is a layer that is composed of a primer layer forming composition containing a silane coupling agent and that is formed through a dehydration condensation reaction of the silane coupling agent.

13. The power storage device packaging material of claim 12, wherein the silane coupling agent is a compound having an amino group.

14. The power storage device packaging material of claim 10, comprising an anticorrosion treatment layer at one or both of a position between the barrier layer and the first adhesive layer and a position between the primer layer and the barrier layer.

15. The power storage device packaging material of claim 10, wherein the adhesive resin layer contains acid-modified polyolefin.

16. The power storage device packaging material of claim 10, wherein
both the adhesive resin layer and the sealant layer contain polypropylene, and
one or both of the adhesive resin layer and the sealant layer contain long-chain branched polypropylene as the polypropylene.

17. The power storage device packaging material of claim 16, wherein a content of the long-chain branched polypropylene with respect to a total amount of resin in the adhesive resin layer and the sealant layer is 0.5 to 30 mass %.

18. The power storage device packaging material of claim 10, wherein a thickness ratio between the adhesive resin layer and the sealant layer (thickness of the adhesive resin layer/thickness of the sealant layer) is 0.06 to 1.

19. The power storage device packaging material of claim 1, wherein the power storage device packaging material is used for an all-solid-state battery.

20. A power storage device comprising:
a power storage device body;
a current output terminal that extends from the power storage device body; and
the power storage device packaging material of claim 1, the power storage device packaging material sandwiching the current output terminal and housing the power storage device body.

21. The power storage device of claim 20, wherein the power storage device is an all-solid-state battery.
